(19) United States
(12) Patent Application Publication
(10) Pub. No.: US 2017/0095834 A1
(43) Pub. Date: Apr. 6, 2017

(54) ELECTROSTATIC DEPOSITION

(71) Applicant: William Brian Kinard, Menlo Park, CA (US)

(72) Inventor: William Brian Kinard, Menlo Park, CA (US)

(21) Appl. No.: 15/284,282

(22) Filed: Oct. 3, 2016

Related U.S. Application Data
(60) Provisional application No. 62/237,077, filed on Oct. 5, 2015.

(51) Int. Cl. B05D 1/00; B05B 5/025

(52) U.S. Cl. CPC B05D 1/007; B05B 5/0255

(57) ABSTRACT

The present design describes systems, apparatuses and methods for improving the efficiency, amount and quality of deposition of material on an object or predetermined portions of an object. The object's surface is coated with a charge by depositing a charged pretreatment material (or first material) on the surface of the object. In another embodiment, predetermined portions of the object's surface are coated with a charge by depositing a charged pretreatment material on the predetermined surfaces of the object. Then, the treatment material (or second material) is charged with an opposite-polarity charge and emitted towards the object where the treatment material exhibits a strong, opposite-polarity charged electrostatic attraction force to the first material, the object or the predetermined portions of the object. The result is an increased, consistent, improved and targeted deposition of the treatment material on the object or the predetermined portions of the object.

The present application claims the benefit of U.S. Provisional Patent Application Ser. No. 62/237,077, filed Oct. 5, 2015, entitled “Improved Electrostatic Deposition,” inventor William Brian Kinard, the entirety of which is incorporated herein by reference.

### BACKGROUND OF THE INVENTION

Field of the Invention

This present design is directed to electrostatic deposition of materials onto an object, and more specifically, to improved electrostatic deposition of materials onto an object by pre-charging the object's surface with a beneficial or benign first material that has an electrical charge polarity opposite to the electrically charged second material later being deposited.

Description of the Related Art

Electrostatic deposition is simply the deposition of liquid and/or small solids onto surfaces using electrostatic forces. Electrostatic deposition has been available for decades but continues to present challenges in different instances.

It is well known in the art that electrically charging a material improves the amount and quality of deposition of that material on a perfectly conducting object that is at ground potential.

Several devices, methods and systems for atomizing and electrostatically depositing material on a grounded object exist. Certain references, for example, discuss using corona ionization to charge liquid droplets, using electrostatic induction charging of liquid droplets, using a rotating disc to atomize fluid and/or atomization and charging of fluid using compressed air without significantly ionizing the air.

Attempts at electrostatic deposition have sometimes employed a three-step, single stage process. First, material is sprayed, divided or formed into finely divided particles or droplets (known sometimes as atomization). Second, the material droplets are charged with a single polarity; and third, the charged material droplets are attracted to and deposited onto a grounded object. In free space between the nozzle and the object, these charged material droplets experience an electrostatic attractive force to the object, which improves the deposition quantity and quality relative to the object's surrounding environment (known as deposition efficiency). A ratio of the charge imparted on a material to the mass of the material (known as charge-to-mass ratio or CMR) of at least 0.8 milli-Coulomb/kg, in free space between the nozzle and the object, is required for any appreciable enhancement in deposition using image-charge electrostatic attraction. Electrostatic attractive forces between the charged material droplets and the grounded object in free space, coupled with the close proximity between the charged material droplets and the object, move the charged material droplets toward the object where the charged material droplets are deposited on the object to form a coating or layer on the object's surface. The two principal differences in the electrostatic deposition systems and methods of such prior designs are (i) the manner in which the material droplets are divided or formed and (ii) the means by which they are charged. A review of prior (single stage) electrostatic processes can be found in Moore, A. D., Ed., Electrostatics and its Applications, Wiley & Sons, 1973.

However, even at appreciable charge-to-mass ratios, the amount and quality of deposition of materials on an object using such previous designs are limited for two principal reasons.

First, such designs deposit electrostatically charged material on a grounded object, which is preferably a perfect conductor. If the object is less than ideal (i.e. finite resistance, capacitance or relative permittivity) or the object is not perfectly grounded, which is often the case in certain applications like agriculture, then the electrostatic attractive force between the charged material and the object is reduced or inconsistent across the object, resulting in decreased deposition efficiency and consistency. Second, such designs deposit electrostatically charged material on a grounded object using the image-charge force, which is based on force between the charged material and the grounded object, and which is as little as one-fourth the force between two similarly situated, charged particles with opposite electrical polarities.

Attempted solutions to these issues have included using opposite-polarity charged particles as an additional step to achieve various goals. Designs have included emitting a positive charge of ions from the front of an airplane to neutralize the charge buildup on the airplane that results from charging and spraying pesticides with the negative-polarity charge from the airplane, and emitting pesticides from an airplane using a combination of positive-polarity charging and negative-polarity charging of the pesticide spray in order to neutralize the charge buildup on the airplane and reduce spray drift.

Other designs have pointed to using like-polarity charged particles as a pretreatment to improve deposition efficiency of electrostatic deposition on agricultural plants. One method uses pre-charged, isolated, plastic sheeting, which is (i) located between crop rows and suspended below crop plants but just above the ground (separated by up to 4 cm from earth) and (ii) charged with air ions of the same charge as the material (up to 15 micro-Coulombs/m²) so that when the material (pesticides) is sprayed from the nozzle towards the plants, the repulsive force from the like-polarity charged plastic sheeting directs more of the material (pesticides) away from the ground and towards the plants.

Still other designs have suggested pretreating insulating objects so as to accept electrostatically charged material. Examples of this include designs where the insulating object is coated with uncharged conducting fluid to aid in electrostatic deposition of the material, and the impingement of ionizing radiation (x-rays or gamma-rays) on a non-conducting object in order to create an oxidized, conducting coating on the object and a conducting path from the object's surface to the ground for the purpose of making the insulating object amenable to electrostatic deposition.

None of these designs, however, substantially improves the deposition efficiency and consistency over single-stage, single-polarity electrostatic deposition of materials on objects that exhibit less-than-ideal electrical characteristics.

The present design seeks to improve the deposition efficiency, amount, quality, consistency and selectivity of material on an object with respect to the surrounding environment, thereby reducing the volume of the material used and minimizing or eliminating waste or harmful environmental effects, and improve the deposition efficiency, amount, quality, consistency and selectivity of material on the predetermined areas of the object with respect to other areas of the object and the surrounding environment, thereby further reducing volume of material used and minimizing or eliminating waste or harmful environmental effects.

In sum, it would be beneficial to provide an electrostatic deposition design that overcomes issues with previously known deposition techniques and enables relatively rapid and efficient electrostatic deposition techniques as compared with prior designs.

### SUMMARY OF THE INVENTION

Thus according to one aspect of the present design, there is provided an electrostatic deposition system, comprising a first nozzle with a first output spray angle, at least one first material reservoir coupled to the first nozzle through at least one first passageway, comprising at least one first material path from at least one first reservoir along one first passageway, through the first nozzle and into a first output spray, at least one first voltage supply in electrical contact with at least one first material, wherein one first voltage supply is referenced to at least one first voltage reference, a second nozzle with a second output spray angle, at least one second material reservoir coupled to the second nozzle through at least one second passageway, comprising at least one second material path from at least one second reservoir along one second passageway, through the second nozzle and into a second output spray, and at least one second voltage supply in electrical contact with at least one second material, wherein one second voltage supply is referenced to at least one second voltage references. At least one of the second voltage references has a polarity or sign opposite to at least one of the first voltage references.

According to a second aspect of the present design, there is provided a method of depositing materials on an object. The method comprises charging at least one first material to a charge-to-mass ratio of at least 0.20 milli-Coulombs/kg, emitting or spraying at least one first material away from the first nozzle into free space, wherein at least one of the charged first materials are attracted to and move toward an object under electrostatic attractive forces between at least one of the first materials and the object, and wherein at least one of the charged first materials deposit on the object and impose or maintain an electric charge on the object or at least one of the first materials on the object, charging at least one second material to a charge-to-mass ratio of at least 0.20 milli-Coulombs/kg and opposite polarity to the charge applied to at least one of the first materials, and emitting or spraying at least one of the second materials away from the second nozzle into free space; wherein at least one of the charged second materials are attracted to, move towards and are deposited on the opposite-polarity charged object or first material on the object.

According to a further aspect of the present design, there is provided a system for depositing material on an object. The system comprises a first nozzle configured to charge a first material to a charge-to-mass ratio of at least 0.20 milli-Coulombs/kg and emit at least a portion of charged first material away from the first nozzle, wherein the first material is capable of suspension in free space and attraction to, movement toward and deposition on the object under electrostatic attractive forces, and wherein the first material is capable of coating or imposing an electric charge on the object or first material on the object, and a second nozzle configured to charge a second material to a charge-to-mass ratio of at least 0.20 milli-Coulombs/kg and emit at least a portion of charged second material away from the second nozzle, wherein the second material is capable of suspension in free space and attraction to, movement toward and deposition on the object or the first material coating the object under electrostatic attractive force.

These and other advantages of the present design will become apparent to those skilled in the art from the following detailed description of the invention and the accompanying drawings.

### BRIEF DESCRIPTION OF THE DRAWINGS

The present design is illustrated by way of example, and not by way of limitation, in the figures of the accompanying drawings and in which like reference numerals refer to similar elements and in which:

FIG. 1 is a functional block diagram showing the electrostatic attraction force of oppositely charged objects.

FIG. 2 is a functional block diagram showing the electrostatic attraction force of a charged object to an ideal, grounded, perfectly conducting, infinite plane.

FIG. 3 is a flow chart of the prior method of atomizing, charging and spraying material on an object.

FIG. 4 is a functional diagram of a typical previously known electrostatic spray deposition system.

FIG. 5 is a flow chart of some embodiments of the present design in two stages (Stage 1 and Stage 2).

FIG. 6 is a functional diagram of Stage 1 (or Pretreatment Stage) of some embodiments of the present design, coating the object with charged pretreatment material (or first material).

FIG. 7 is a functional diagram of Stage 2 (or Treatment Stage) of some embodiments of the present design, spraying the opposite-polarity charged treatment material (or second material) on the charged object.

FIG. 8 is a typical prior agricultural terrestrial sprayer, which sprays material (uncharged or electrostatically charged) on agricultural plants.

FIG. 9 represents some embodiments of the present design—an agricultural terrestrial sprayer, which sprays charged pretreatment material (front booms) on the agricultural plants and then sprays opposite-polarity charged treatment material (back booms) on the agricultural plants.

### DETAILED DESCRIPTION

The following description and the drawings illustrate specific embodiments sufficiently to enable those skilled in the art to practice the system and method described. Other embodiments may incorporate structural, logical, process and other changes. Examples merely typify possible variations. Individual elements and functions are generally optional unless explicitly required, and the sequence of operations may vary. Portions and features of some embodiments may be included in, or substituted for, those of others.

The following description refers to “some embodiments.” Note that “some embodiments” describes a subset of all of the possible embodiments, but does not always specify the same subset of embodiments. Further, this does not limit the permutations or combinations of all or parts of embodiments in the present design.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure. The recitation of numerical ranges by endpoints includes all numbers within that range (e.g. 2 to 4 includes 2, 2.3, 3, 3.60, and 4).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

As used in this specification and the appended claims, use of the word “including” means also “including without limitation” unless the content clearly dictates otherwise.

The present design improves the deposition efficiency and consistency over single-stage, single-polarity electrostatic deposition of materials on objects that exhibit less-than-ideal electrical characteristics. Further, the present design provides for coating the surface of an object with charged first material in order to improve the deposition efficiency and consistency of opposite-polarity charged second material on the object.

Generally, in electrostatic deposition, the charged material being deposited, preferentially on the object, travels in free space between the nozzle and the object and is subjected to one or more external forces, including gravity and the electrostatic force of attraction between the material and the object. Maximizing the charge of the droplets or particles of material relative to its mass (known as charge-to-mass ratio or CMR) increases the electrostatic force of attraction of the material droplet or particle relative to the other outside forces, thereby increasing the probability that the material droplet or particle will deposit preferentially on the object; and for a plurality of material droplets or particles, the higher ratio of charge to mass will increase the deposition efficiency, which is the ratio of material droplets or particles deposited on the object divided by the total material droplets or particles leaving the nozzle for a given time period. Assuming that charge resides uniformly on the surface of the droplet or particle of material and the surface charge density (Coulombs/cm²) is the same from one material droplet or particle to the next, then the droplets' or particles' charge is proportion to its surface area. For spheroidal droplets or particles of material, the surface area is roughly directly proportional to the square of the radius of the spheroid. This means that the droplets' CMR is roughly inversely proportion to the spheroid's radius according to the following equation:

$$CMR = \frac{σ * S}{ρ * V} ∼ \frac{1}{R}$$

where σ is the spheroid's surface charge density (Coulombs/cm²), ρ is the droplet's density (kg/cm³), S is the droplet's surface area (cm²) and V is the droplet's volume (cm³). In sum, the CMR is increased for designs in the literature and some embodiments of the present design by decreasing the size of the droplets or particles of material for a given surface charge density. In prior references and some embodiments of the present design, this increased CMR can be achieved by dividing, forming, atomizing or pulverizing the material into small pieces, either before, during or after charging or emitting from the nozzle.

Various methods are disclosed to increase the CMR of materials or chemicals. If charge is imparted on a material's surface, then dividing or atomizing the material into small droplets or particles (either prior to, substantially contemporaneously with, or after charging) increases the surface area per unit volume, which increases the CMR. As used in this specification and the appended claims, use of the words “form,” “atomize,” “divide,” “powdered,” “pulverize” or “granulate” in the present design and embodiments in no way limits these words to any specific method or system of breaking apart, dividing, or forming a material into smaller parts. A system for atomizing a material can be described variously, including atomizer, sprayer, fine-mister, aerosol, duster or vaporizer.

As used in this specification and the appended claims, use of the words “charge” or “charging” in the present design and embodiments in no way limits these words to a specific method or system for imparting an electrical charge in or on a material.

As used in this specification and the appended claims, use of the words “spray,” “spraying,” “emit,” or “emitting” in the present design and embodiments in no way limits these words to any specific method or system of imparting force or momentum on material or having force or momentum imparted on material.

As used in this specification and the appended claims, use of the adjectives “treatment” or “pretreatment” in the present design and embodiments in no way limits the type, function or purpose of material used in the present design or some of its embodiments.

As used in this specification and the appended claims, use of the word “material” in the present design and embodiments in no way limits the word “material” to any specific material, chemical, composition or state. Material can mean, among other things, matter, chemical elements, chemical substances, chemical compounds, alloys or mixtures. Moving between solid, liquid, gas and plasma has no effect on its material identity. For example, water remains water, no matter if it be solid, liquid or gas. Further, material can be a collection of atoms or molecules in whatever structure, mixture or energy state.

Efficiently and consistently depositing materials (including without limitation plant chemicals, paints, dyes, powders, coatings, disinfectants, etc.) on objects (including without limitation plants, crops, food, industrial and consumer equipment and parts, animals and humans) has been the subject of considerable investment and effort because of the benefits it provides to our society. Efficient deposition of materials minimizes overspray on unwanted areas, which not only decreases the manufacturing costs and therefore increases the value of objects but also improves the environment if the overspray of materials (including some paints and pesticides) is damaging to the environment. Finally, consistent deposition of materials on objects improves the adoption and usage of these technologies.

For almost ninety years, electrostatic deposition in some applications has improved the deposition efficiency and quality of materials on objects compared to conventional spraying. For example, electrostatic spraying of paints and powders on industrial equipment is broadly used. Electrostatic spraying involves several processes different from or in addition to conventional spraying:
Divide or atomize the material into small pieces (usually spheroidal pieces less than about 100 micrometers in diameter). If the material is solid, divide or pulverize the material into a powder, which is usually done before emitting or spraying. If the material is a liquid, divide the material using one of numerous atomizing techniques, including without limitation, mechanical vibration, rotary atomization, hydraulic pressure, pressurized gas such as air etc., which can be done before, during or after charging or spraying the material.
Apply charge to the small pieces of material. Prior designs have shown that one metric is important to effective electrostatic deposition of materials on objects—maximize the charge collected on a given mass of material, known as charge-to-mass ratio or CMR.
Spray or emit the electrostatically charged, atomized treatment material into free space towards the grounded object using force or momentum, including hydraulic pressure, pressurized air or gravity.

However, despite considerable promise and effort, prior-art methods of electrostatic deposition of materials on objects have not been broadly adopted in some industries and applications, principally agriculture. This is because application of pesticides (herbicides, insecticides and fungicides) and other plant materials on agricultural crops oftentimes deviates considerably from ideal electrostatic deposition conditions, which results in significantly reduced or unpredictable efficacy of electrostatic spraying on agricultural crops. The reasons why electrostatic deposition of treatment materials on objects has not been broadly adopted in some industries and applications, principally agriculture, will be discussed below.

The present design improves the deposition efficiency, selectivity, amount, consistency and quality of liquids or solids (pulverized or granulated powder, either alone or suspended in liquid) material on an object, even if the object is not a perfect conductor or perfectly grounded. Also, some embodiments of the present design work considerably equally for a plurality of objects with differing electrical properties and ground potentials such as different agricultural crops or even the same types of agricultural plants within different parts of a field. Some embodiments of the present design pretreat (or coat) the surface of an object with charge prior to depositing the opposite-polarity charged treatment material (or second material) on the object. These embodiments of the present design accomplish this by charging a benign or beneficial pretreatment material (or first material) and depositing this charged pretreatment material on the object's surface prior to the deposition of the opposite polarity charged treatment material (or second material) on the object.

Embodiments of the present design provide charged pretreatment material deposits on the object's surface and maintain all or a significant portion of this charge until the opposite-polarity charged treatment material is deposited on the object. Because the force of attraction of the charged treatment material to the opposite-polarity charged pretreated object is based principally on opposite-charge (versus image-charge) attractive forces, as in certain prior references, these embodiments of the present design enjoy an immediate up to four-fold increase in attractive force between the treatment material and the object's surface. Further, because the charged pretreatment material on the object does not suffer from the less-than-ideal and varying electrical properties of the object itself, these embodiments of the present design are much more consistently applied than previous applications. Finally, it is not obvious to one skilled in the art that charged pretreatment of an object's surface prior to deposition of the opposite polarity charged treatment material significantly improves the deposition selectivity, consistency and quality of treatment material on an object.

Forces exerted on a charged object, in the presence of either another charged object or a perfectly conducting, grounded object, are well known.

The present design provides systems, apparatuses and methods for increasing the efficiency of deposition of material on an object or portions thereof, which comprise spraying, charging and coating the object with a thin layer of charged first material followed by spraying, charging and coating the object with the second material, which has a charge that is opposite polarity to the polarity of charge of the first material.

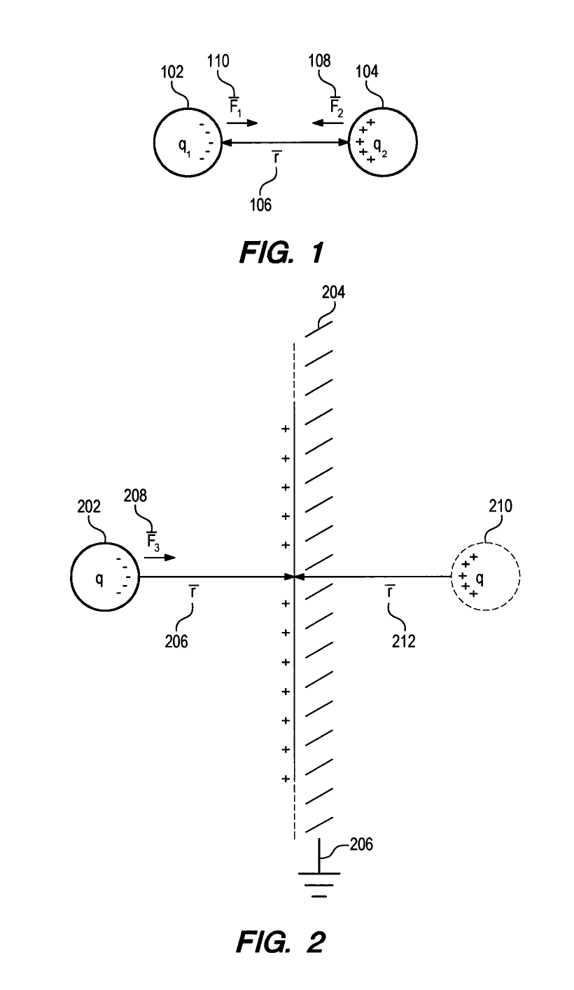

FIG. 1 shows a negative-polarity charged sphere 102 separated by a distance r 106 from a positive-polarity charged sphere 104. The negative-polarity charged object 102 is attracted to the positive-polarity charged object 104 by a force F₁ 110 according to the following equation:

$${F}_{1} = {F}_{2} = \frac{{q}_{1} {q}_{2}}{4 π {ɛ}_{0} {r}^{2}}$$

where q₁ and q₂ are the charges applied to charged objects 102 and 104 respectively (Coulomb), r 106 is the distance between two spheres (meters), and ε₀ is the permittivity of free space (£₀=8.854×10⁻¹² Farad/meter or Coulomb²/Newton×meter²).

Similarly, the positive-polarity charged object 104 is attracted to the negative polarity charged object 102 by an equal force F₂ 108 according to the same equation.

Also, if the charged objects 102 and 104 are like-polarity charged (as opposed to opposite-polarity charged as discussed above), the forces F₁ 110 and F₂ 108 will be the same as above but in the opposite direction so that the like-polarity charged objects 102 and 104 are repulsed from each other.

FIG. 2 shows a negative-polarity charged sphere 202 separated by a distance r 206 from a perfectly conducting, infinite plane 204, which is perfectly grounded 206. The conducting plane 204 establishes a positive-polarity charge on its surface nearest the negative-polarity charged sphere 202, which establishes a force F₃ 208 on the charged sphere directed perpendicular to the conducting plane 204. Conversely, if the charged sphere 202 were positive-polarity charged with the same amount of charge, the force F₃ 208 would be the same and still attracted towards the conducting plane 204 because the conducting plane 204 would similarly establish a negative-polarity charge on its surface nearest the positive-polarity charged sphere 202. By analogy, the conducting plane 204 can be replaced with a phantom “image charge” 210 perpendicular to and within the conducting plane 204 by an equal distance r 212 perpendicular to the surface of the plane 204, and the “image charge” 210 will have the same properties (charge, size and permittivity) as the charged sphere 202 but with opposite-charge polarity.

Under this analogy, the force F₃ 208 exerted on the charged sphere 202 towards the conducting plane 204 will be according to the following equation:

$${F}_{3} = \frac{{q}^{2}}{4 π {{ɛ}_{0} ( 2 r )}^{2}}$$

where q is the charge applied to charged object 202 (Coulomb), r 206 is the distance from the charged sphere perpendicular to the conducting plane 204 (meter), and ε₀ is the permittivity of free space (Farad/meter or Coulomb²/Newton×meter²).

Previous references indicate that a CMR of at least 0.8 milli-Coulomb/kg, in free space between the nozzle and a less-than-ideal agricultural plant, is required for any appreciable enhancement in deposition on the agricultural plant using image-charge electrostatic attraction. Translating this to the force equation above, prior references indicate that a force F₃ (N) of attraction of the charge particle to the object, multiplied by the square of the distance r (m²) of the droplet or particle of material perpendicular to the surface of the object, and then divided by the square of the mass (kg²) of a droplet or particle of material should be greater than about 1,438 (N m²/kg²) in order to achieve appreciable electrostatic attraction of a charged particle on a less-than-ideal agricultural plant. This is known as the normalized electrostatic force of attraction or NEFA. This is an important measure because NEFA can determine the quality of electrostatic deposition of one or a plurality of charged material droplets or particles without factoring in mass of the droplet or particle and distance of the droplet or particle from the object, both of which are more difficult to control or measure. Further, NEFA can be measured for one or a plurality of material droplets or particles by measuring the CMR of the one or plurality of material droplets or particles and using either or a combination of the force equations described above.

In some applications, including agriculture, where external forces such as wind and turbulence adversely affect the deposition efficiency, especially under the circumstances where the size of the material droplets or particles are decreased in order to increase the CMR. For example, in agricultural applications, decreasing the diameter of material droplets or particles below about 30 to 60 micrometers usually results in substantial spray drift from the forces of wind and turbulence. This size seems to be a tipping point of increased CMR (beneficial) but increased spray drift (detrimental) for agricultural applications. However, the increased attractive force of some embodiments of the present design should permit larger droplet sizes (up to about 100 micrometers in diameter and possibly beyond) without adversely affecting the deposition efficiency compared to prior designs, which can also decrease spray drift in some agricultural applications.

The image-charge force depends on several key assumptions—the conducting plane 204 is infinitely large, perfectly conducting (about zero resistance and capacitance with about infinite relative permittivity) and about perfectly grounded. Deviations from these assumptions typically result in a reduction in force F₃ 208, which will decrease the transfer efficiency or transfer probability of the object 202 onto the conducting plane 204 for the same CMR, especially when the charged object 202 is subject to one or more additional forces in the free space such as gravity, wind, turbulence or space charge repulsive forces between other like-polarity charged objects. Further, when the object 202 touches the conducting plane's surface 204, most if not all of the charge in object 202 will be quickly discharged onto the surface 204, depending on the properties of the object 202 (including resistivity, relative permittivity or surface tension). In some embodiments of the present design, proper selection of the properties of the charged object 202 (including resistivity, relative permittivity or surface tension) can result in the charged object 202 retaining up to all of its charge for a considerable period of time after it has physical contact with the surface 204.

Because prior designs use image charge for attracting and depositing material on an object, such designs suffer from deviations and degradation in the ideal assumptions mentioned above.

In the present design, forces F₁ 110 and F₂ 108 in FIG. 1 are on the order of four times the force F₃ 208 in FIG. 2 for the same distance r 106 in FIG. 1 and r 206 in FIG. 2. Because (as will be described below) previous designs use image charge for attracting and depositing material on an object whereas some embodiments of the present design use primarily opposite-polarity charge for attracting and depositing material on an object, some embodiments of the present design provide up to four-fold increase in force for the same CMR and distance compared to previous known designs. This up to four-fold increase in force for the same separation distance and CMR results in a higher deposition efficiency on the object under the same conditions. This is known as the Image-Charge Penalty.

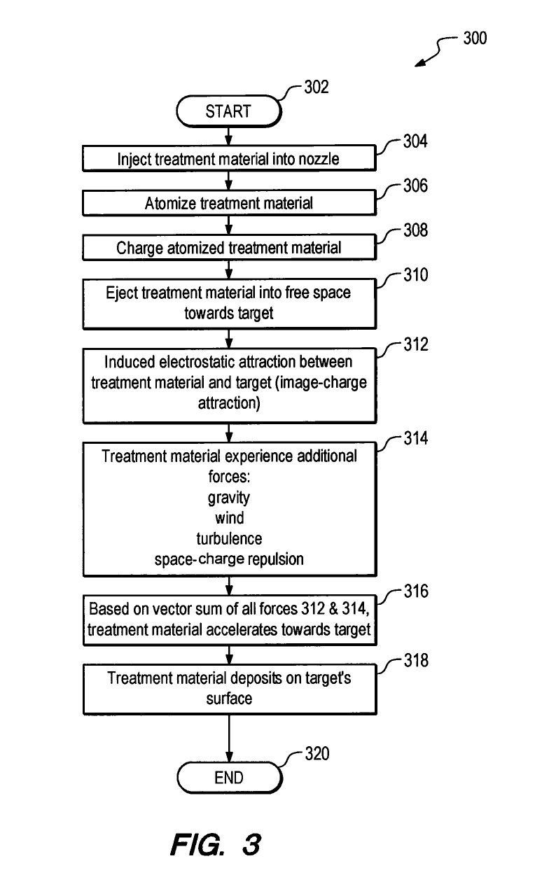

FIG. 3 is a process flow chart showing the general steps in atomizing, charging, spraying and depositing treatment material (or first material) on an object (or target). The typical previously known electrostatic process 300 starts 302 by injecting the material into the nozzle 304 where the material is then atomized 306 into small droplets. One of the metrics of effective electrostatic deposition is maximizing charge-to-mass ratio, which means that the droplets of material are sufficiently small to maximize the surface area per mass of the material. The high surface area to mass of a droplet means that the droplets can acquire as much charge as possible in electrostatic processes resulting ultimately in increasing the electrostatic force of attraction of the droplet to the object. It has been noted in previous designs that for some applications in agriculture, for large plants and trees or where the agriculture plant is large and has a large canopy, too large of a CMR results in poor deposition into the internal parts of the canopy. Earlier designs have suggested in these instances to decrease the CMR of the material to penetrate the canopy of large agricultural plants or trees.

Alternatively, if the material is a dry powder or pulverized solid, then the material is presumably already at sufficiently small size, and the atomization step 306 is eliminated in prior processes. Liquids separate, divide and atomize when the liquid is subjected to external shear forces, and the literature points to numerous methods to atomize liquids, including mechanically using vibrations or rotating discs, aerodynamically, pneumatically, and hydraulically through high pressure and small orifices. The atomized material is then charged 308 using one of several means—corona ionization charging, induction charging, and direct charging to name a few.

A good overview of the three principal methods of prior electrostatic charging (corona charging, induction charging and hydrodynamic or direct charging) can be found in Brent, K. J. and Atkin, R. K., Rational Pesticide Use, Cambridge University Press, 1987, pp. 83-85, and a good overview of the whole electrostatic deposition process can be found in Law, S. E., Electrostatic Atomization and Spraying, in Chang, J., Kelly, A. and Crowley, J. M., Handbook of Electrostatic Processes, Marcel Dekker, Inc., 1995, pp. 413-440, the entirety of both of which are incorporated herein by reference.

Electrohydrodynamic charging, electrodynamic charging and direction charging will be collectively known herein as direct charging. Previous designs have shown that certain charging techniques work better for different treatment materials. For example, induction charging works better for lower-resistivity treatment materials (about 10⁻¹-10⁴ Ohm m) although the CMR is sometimes reduced, and direct charging works better for higher resistivity treatment materials (about 104-109 Ohm m and beyond) and pulverized solids or powders. Also, corona ionization charging works sufficiently for treatment materials of any resistance, although the CMR is sometimes reduced. The charged material is then ejected 310 from the nozzle into free space (air as an example) by force or momentum (including pneumatic, hydraulic pressure, air-assisted pressure, gravity or electrodynamic), usually towards the object. There are many examples of electrodynamic pumps. U.S. Pat. Nos. 4,398,589, 4,566,859, and 3,515,898, for example, describe various electrodynamic pumps for conveying material through a conduit or a nozzle. An “electromagnetic conduit” is described by U.S. Pat. No. 4,216,800 wherein electrical conductors are disposed along an axis, which coincides with the axis to be imposed on a stream of material. Now in free space, the atomized, charged material experiences an attractive electrostatic force 312 towards the grounded object. As noted above and in FIG. 2, this attractive force is directly proportional to the amount of charge on the material droplet or particle and inversely proportional to the square of the distance between the material droplet or particle and the object, which means that the force increases substantially as the material droplet or particle approaches the object's surface to the point where the electrostatic force of attraction 312 is significantly greater than the other forces 314 including gravity, turbulence from wind, turbulence from movement of the electrostatic deposition system, force or momentum of the droplet or particle ejecting from the nozzle and space-charge repulsion of like-polarity charge droplets or particles of material, to the point where the droplet or particle of material accelerates towards the object 316 and attaches to the surface of the object 318.

The fundamental goal of previous designs is to maximize deposition efficiency (defined as the number of material droplets or particles attaching to the object divided by the total number of material droplets or particles emitted from the system over a given time period). However, if the CMR is low, if the other forces are significantly stronger than the attractive electrostatic force between the material droplet or particle and the object or if the material droplet or particle is emitted from the system at the wrong trajectory, then the material droplet or particle will not attach to the object thereby reducing the deposition efficiency. Although a start 302 and end 320 are shown on this process flow chart, the described prior process 300 is a continual process where a plurality of droplets or particles of material are continually atomized, charged, emitted and deposited on the object or series of objects. Further, although the process 300 describes only one droplet or particle of material being atomized, charged, emitted and deposited on the object, numerous droplets are being atomized, charged, emitted and deposited on the object simultaneously and serially.

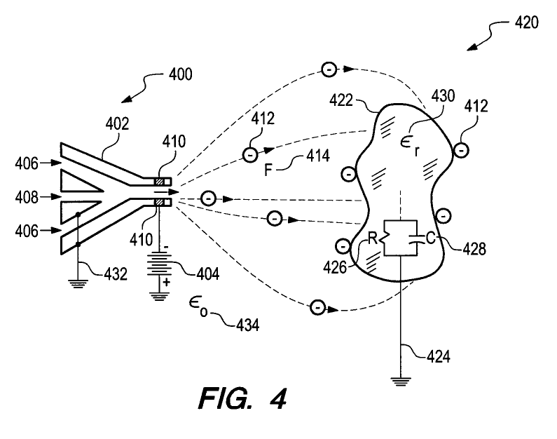

There are many systems and methods for atomization, charging, spraying and electrostatic deposition, and although some of the steps described in FIG. 3 may be switched with other steps or occur simultaneously with other steps, the general process is generally the same for all prior systems and methods. As one example, induction charging, the material is usually atomized simultaneously during the highest induction field intensity, which means that the steps of atomizing 306 and charging 308 occur substantially simultaneously. Although the literature in certain instances points to different systems, apparatuses and methods of atomizing material, charging, spraying and depositing the material on an object, the state of the art can be generally described in the functional diagram in FIG. 4, which is generally applicable to all prior electrostatic deposition systems and methods.

The process flow of the representation in FIG. 3 can be shown diagrammatically in FIG. 4. The electrostatic emitter apparatus 400 is a cutout view of the electrostatic induction-type nozzle, including atomizer, charger and emitter. The fundamental goal of electrostatic deposition is to maximize the amount, quality and consistency of material 412 that is emitted from the electrostatic nozzle 400 and deposited on the object's surface 422. More specifically the material 412 is injected into the nozzle 400 through the nozzle orifice 408, using, as one example, hydraulic force. The material is divided or atomized by one or more energy inputs 406 that break up or shear the treatment material into small droplets or particles, usually less than about 100 micrometers.

In the current configuration, pressurized air is injected into the inputs 406, and the physical structure of the emitter apparatus 402 combines with pressurized air's and the material's movement through the nozzle 400 to divide or atomize the material. The emitter apparatus 402 and material are usually at ground potential 432 at this point. Upon ejection or sprayed from the emitter apparatus 402, the atomized material 412 is subject to ions created by the high negative voltage potential 404 and induction annular ring 410, which circumscribes the exit orifice of the emitter apparatus 402, and the atomized material droplets 412 are thus charged, usually with a negative polarity. The amount of charge acquired per unit mass determines its CMR. The charged material 412 is then ejected from the emitter apparatus 402 at an initial force and momentum (including pneumatic, hydraulic pressure, air-assisted pressure or electrodynamic) and direction into free space 434 (air as an example), usually towards the object 420. Now in free space 434, the atomized, charged material 412 experiences an electrostatic attractive force 414 towards the grounded object 420. The atomized, charged material 412 experiences one or more additional forces, including one or more of these five additional forces—(i) gravity, (ii) turbulence from wind, (iii) turbulence from movement of the electrostatic deposition system, (iv) force or momentum from ejection from the emitter apparatus 402 and (v) space-charge repulsion of like-polarity charged droplets of treatment material 412 in free space 434. For simplicity, these five additional forces are not shown in FIG. 4.

The primary goal of electrostatic deposition is that when the electrostatic force of attraction 414 towards the object 420 is significantly greater than the vector sum of the other additional forces, the droplet or particle of material 412 accelerates towards the object 420 and attaches to the surface of the object 422. However, in addition to or in conjunction with the five disruptive forces mentioned above, one or more of several circumstances can cause the material droplet or particle 412 to fail to accelerate to and attach to the object 420 thereby reducing the deposition probability or efficiency:
if the CMR of the material droplet 412 is too low, reducing the attractive force 414 relative to one or more of the five additional forces,
if one or more of the five additional forces are significantly stronger than the electrostatic attractive force 414 between the material droplet 412 and the object 420;
if the material droplet 412 is emitted from the emitter apparatus 402 at the wrong trajectory or momentum; or
if the object 420 exhibits characteristics (including finite resistance R 426, finite capacitance C 428, finite relative permittivity Er 430 or poor ground potential 424) that are less than ideal (i.e. zero resistance R 426 and capacitance C 428, infinite relative permittivity εᵣ 430, and perfect ground potential 424) thereby reducing the force of attraction 414.

As stated above, the fundamental problem with prior designs is that some applications provide objects with less-than-ideal electrical characteristics thereby reducing deposition probability or efficiency. The object 420 in some applications, like agriculture, can be described simplistically as a finite distributed resistance R 426 in parallel with a finite distributed capacitance C 428 and a finite relative permittivity εᵣ 430. In addition, a relatively poor connection to ground potential 424 will deviate from the ideal deposition probability or efficiency. Certain references have estimated that the resistance R 426 and capacitance C 429 for a typical agricultural plant are about ˜108 Ohms and ˜120 pF respectively, although these values can vary by several orders of magnitude based on numerous factors, including without limitation the following: (i) the plant's physical characteristics (including height, canopy size, leaf size and shape, number of leaves and root structure), (ii) morphological characteristics of the plant's leaves or stems, (iii) the plant's growth stage or (iv) the amount of fluid in the plant or ground. Higher-order models for agricultural plants can be found in the literature, more specifically in Zhang, M. I. N. and Willison, J. H. M, Electrical Impedance Analysis in Plant Tissues: Impedance Measurement in Leaves, Journal of Experimental Botany, Vol. 44, No. 265, pp. 1369-1375, August 1993, in which the electrical resistances (i.e. extracellular resistance, cytoplasmic resistance and vacuole interior resistance) and capacitances (i.e. plasma membrane capacitance and tonoplast capacitance) of each leaf and stem are modeled; and the complex, higher-order electrical model of the whole plant can then be assembled, modeled and exploited. In addition, Singh et al. have measured significant variability and high relative resistivity (about ˜120 Ohm m) in field soil down to about 0.2 meter depth. See, Singh et al., Field Evaluation of Tractor Mounted Soil Sensor for Measurement of Electrical Conductivity and Soil Insertion/Compaction Force, Scientific Journal of Agricultural Engineering, No. 3, 2015, pp. 33-42. The entirety of these references and all references cited herein are incorporated herein by reference.

What is important for some embodiments of the present design, however, is that the electrical characteristics of a plant in agriculture applications can be significantly less than ideal and significantly varying from one plant to the next. The results of less-than-ideal objects 420 are decreased or inconsistent attraction force 414 between the object's surface 422 and the charged material 412 resulting in decreased deposition probability or efficiency. This means that more of the material 412 fails to reach the object 420 and either falls to the ground or is diverted due to the additional forces—gravity, wind or turbulence caused by the spray energy or the mechanism that delivers the deposition system 400 in proximity to the object 420, including spray drift and overspray. Further, the resistance R 426, capacitance C 428, relative permittivity εᵣ 430 or ground potential 424 may vary from one object to the next resulting in different deposition efficiencies from one object to the next.

In agricultural applications, as one example, this means that the prior methods may work adequately with one type of agricultural plant and not work well with another type of agricultural plant; and even within one agricultural crop field, the prior methods may work differently from one part of the field to the next. This variability and complexity have contributed to lack of adoption of previous designs in agriculture. As mentioned above, another weakness of prior designs is that deposition depends on image-charge attraction, which suffers from the Image-Charge Penalty.

FIG. 4 shows a plurality of droplets of negative-polarity charged treatment material 412 in free space 434 after ejection from the emitter apparatus 402 (both simultaneously and serially), and each droplet 412 exhibits independent force 414 (except for mutual repulsion) and acceleration to different parts of the object's surface 422, which results naturally from the unique parameters of each droplet of material 412, including without limitation the following:
the five additional forces described above on each droplet 412;
droplet's 412 size and mass, which factor into the other forces, including gravity, wind, and turbulence;
droplet's 412 CMR, which is a factor in the electrostatic force 414 as well as the repulsive force of like-polarity charged particles in free space 434 and on the object's surface 422;
time of exit of the droplet 412 relative to movement of the nozzle 400 (if any);
trajectory or momentum of exit of the droplet 412 from the emitter apparatus 402, especially relative to the object 420;
space-charge repulsion of like-polarity charged droplets 412 in free space 434 from other like-polarity charged droplets 412 in free space 434 and on the object's surface 422;
possible back-corona repulsion of the droplet or particle 412 from the object 420 resulting from sharp edges on the object's surface 422 causing like-polarity charged ion or particle discharge into free space 434;
possible charge neutrality of the droplet or particle 412 in free space 434 combining with opposite-polarity charged ions or particles emitting into free space 434 from sharp edges on the object's surface 422; and
localized electrical differences (including resistance, capacitance, relative permittivity or ground connection) of different portions of the object 420.

Law and Scherm in “Electrostatic Application of a Plant-Disease Bio-Control Agent for Prevention of Fungal Infection Through the Stigmatic Surfaces of Blueberry Flowers” argue that the amount of time (relaxation time) that it takes positive charge to collect on the desired portions of the object (about ˜48 ms) (assuming R equals about ˜0.4 mega Ohms and C equals about ˜120 pF for a smaller plant) is much less than the negatively-polarity charged electrostatic deposition event (about ˜500 ms), which means that the agricultural plant is a sufficiently conducting object to permit complete deposition. However, the laboratory experiments performed by Law and Scherm do not take into account the less than ideal electrical characteristics and variability of plants experienced in the field.

Additionally, the experiments performed by Law and Scherm still suffer from the Image-Charge Penalty. See also, Law, S. E. and Cooper, S. C., “Object Grounding Requirements for Electrostatic Deposition of Pesticide Sprays,” Trans. ASAE, Vol. 32-4, 1989, pp. 1169-1172 where grounding of plastic-potted greenhouse plants is required for adequate deposition using prior designs. Some embodiments disclosed herein do not require grounding the plastic pots in greenhouse applications.

Further, Law in “Handbook of Electrostatic Processes,” Marcel Dekker, Inc., 1995, p. 427 indicates that if the object's surface 422 contains sharp points, like the tips and edges of leaves of an agricultural plant, the space charge created by the charged, atomized material 412 in free space 434 near the object 420 will induce a corona at the object's edges 422, which will emit like-polarity charged ions and repel charged droplets 412 from the object 420, resulting in “halving” the deposition efficiency of prior designs. Law stated “this effect could have serious implications concerning achieving biologically important deposition onto certain plant components.” However, by coating and precharging the surface of the object with opposite-polarity charged pretreatment material prior to spraying the object with charged material, some embodiments of the present design will significantly diminish or eliminate the repelling effect and reduced deposition efficiency of back corona experienced in prior designs.

As stated above, there are many known systems, apparatuses and methods for electrostatic atomization and deposition, and although some of the steps described in FIG. 4 may be switched with other steps or occur simultaneously with other steps, the general processes (atomization, charging and spraying) are the same for all prior systems, apparatuses and methods. As one example, induction charging requires that the treatment material be atomized simultaneously during the highest induction field intensity. As another example, atomization and charging of the material 412 occur substantially simultaneously in induction charging.

One of the goals of some embodiments of the present design is to maximize deposition efficiency using electrostatic coating technology.

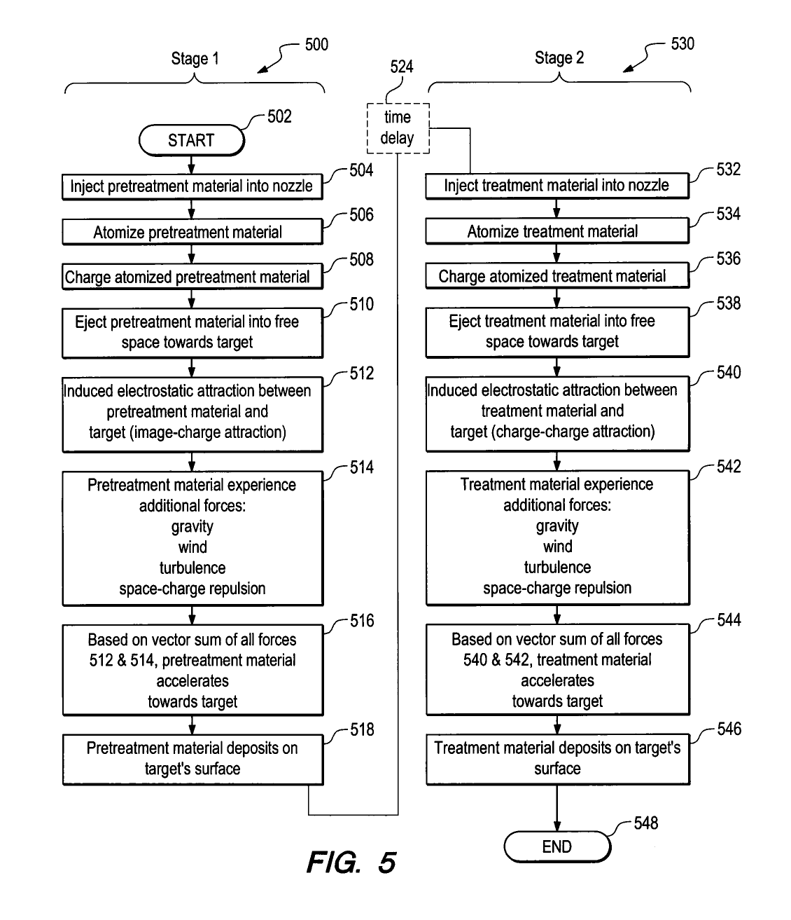

However, contrary to the prior work in this area, some embodiments of the present design largely overcome the real-world limitations of objects with inconsistent or less-than-ideal electrical characteristics. Some embodiments of the present design achieve this by a two-stage process of (i) coating the object with charged pretreatment material (or first material), which may mask all or a portion of the object's inconsistent and less-than-ideal electrical characteristics (known as Stage 1 or the Pretreatment Stage), and then (ii) dividing or atomizing, charging (with opposite-polarity charge from the pretreatment material) and emitting or spraying the opposite-polarity charged treatment material (or second material) on the object (known as Stage 2 or the Treatment Stage). These two stages are generally described in the process flow chart in FIG. 5.

In FIG. 5, Stage 1 (or Pretreatment Stage) 500 of some embodiments of the present design start by injecting the pretreatment material (or first material) into the nozzle assembly 504 where the pretreatment material is divided (including atomized or pulverized) 506 into droplets or small particles. The divided or atomized pretreatment material is charged 508 using one of several means, including without limitation corona ionization charging, induction charging, or direct charging to name a few. Corona ionization charging works sufficiently for treatment materials of any resistance, but any of the prior charging, atomizing and spraying systems and methods work for the present embodiment depending on the characteristics of the chosen pretreatment material. The charged pretreatment material is ejected 510 from the nozzle into free space (including air) by force or momentum (including pneumatic), usually towards the object. Now in free space, the divided or atomized, charged pretreatment material experiences an attractive electrostatic force 512 towards the object. As noted above and in FIG. 2, this force is directly proportional to the amount of charge in the pretreatment material droplet or particle and inversely proportional to the square of the distance between the pretreatment material droplet or particle and the object, which means that the force increases substantially as pretreatment material droplet or particle approaches the object to the point where the electrostatic force of attraction 512 is significantly greater than the other forces 514 exerted on the droplet or particle, including gravity, turbulence from wind, turbulence from movement of the electrostatic deposition system and space-charge repulsion of like-polarity charged droplets of pretreatment material, to the point where the droplet or particle of pretreatment material accelerates towards the target or object 516 and attaches to the surface of the object or target 518. One of the purposes of this Stage 1, in some embodiments of the present design, is to maximize deposition probability or efficiency of the pretreatment material (and thus surface charge density) (Coulombs/cm²) on the object's surface.

In some embodiments of the present design, the pretreatment material in Stage 1 500 must meet one or more of three criteria:
The pretreatment material divides or atomizes and acquires a substantial amount of charge to maximize its CMR;
After being deposited and attached to the object, the pretreatment material must hold a substantial portion of charge for sufficient time for the treatment material to be divided or atomized, charged, ejected and then deposited on the object (Stage 2 below), known as maximum temporal displacement; and
The pretreatment material must not materially, adversely affect the efficacy or purpose(s) of the treatment material (or second material), including its chemical or biological purposes.

In one or more embodiments of the present design, it has been found that most pretreatment materials readily acquire charge or maintain charge, but not both. In one or more embodiments of the present design, dry powdered or pulverized materials have the desired properties of acquiring charge and then holding charge when attached to the object, but in one or more embodiments of the present design powdered or pulverized materials have been found to be somewhat more difficult to handle in field applications, especially when the follow-on (Stage 2) treatment material is a fluid. However, it has been found that, in one or more embodiments of the present design, powdered or pulverized materials suspended in liquid at relatively low and moderate viscosities do have the wanted properties of acquiring and then holding charge and are purchased, stored, handled, electrostatically treated and deposited much like fluids. In some agricultural applications and in one or more embodiments of the present design, some suspended solids do not materially, adversely affect the pesticide treatment material (or second material) (Stage 2 below) and have the added beneficial effect of serving as an adjuvant fungicide or insecticide. Certain particle film technologies (PFT) are basically aqueous formulations made from chemically inert clay or mineral particles, which are specifically formulated for coating agricultural plants to reduce the damage caused by insects, diseases, solar injury, freeze injury and to improve finish, color, carbon assimilation rate, yield and postharvest product quality. These PFTs serve as an effective pretreatment material (or first material) in some embodiments of the present design.

In 1999, Engelhard Corporation of Iselin, N.J. first developed and commercialized such kaolin-based formulation, Surround®. During the past fifteen years, a significant amount of research work has been conducted on the development of several such films (Surround® CF, Surround® WP, Raynox®, Cocoon™, Purshade™, Parasol®, Screen®, Snow®, Eclipse™, etc.) and their effects on various agricultural and horticultural crops. These highly resistive clay or mineral particles have been found in some embodiments of the present design to enhance the CMR for electrostatic spraying, which makes them applicable for one or more of the first materials. These powders suspended in fluids can be charged using corona charging or direct charging, as one of many embodiments of the present design. The product literature for Surround® WP states that this material is most effective if (i) sprayed as a fine mist (atomized) and (ii) coated on both sides of plant leaves; so electrostatic application of the PFT fluids should improve the efficacy of the PFT as well as serve as a charged material for the second material deposition. For liquid pretreatment materials (or first materials), in some embodiments of the present design, it has been found that fluids with high resistivity and high surface tension hold charge the longest on objects, especially objects with less-than-ideal electrical characteristics. Some embodiments of the present design use deionized water (known as DI water) as the pretreatment material. DI water has a high resistivity (about 10⁴ Ohm m), high surface tension (about ˜70 mN/m @ 25° C.) and high relative permittivity (about εᵣ≈80), which one or more of these enhance DI water's ability to (i) coat the object, (ii) not be absorbed into the object and (iii) not give up an appreciable portion of its charge to the object or air for a considerable amount of time.

For highly resistive pretreatment materials, like DI water, electrostatic charging using corona charging or direct charging are two of several methods of charging the material to acceptable CMR. Further, because the CMR using corona charging has been found to be inversely proportional to surface tension, direct charging of DI water, which has high resistivity and high surface tension, is the one of the preferred methods for electrostatic charging in some embodiments of the present design. In his article, Depositional Control of Macroscopic Particles by High-Strength Electric-Field Propulsion, IEEE Transactions on Industry Applications, Vol. 1A-10, No. 4, July/August 1974, pp. 511-519, Ron A. Coffee notes on page 516 that “if the [pretreatment material] is a good insulator, its charge will leak away very slowly except at the very small area(s) of the actual contact, and the electrostatic force will be active for a considerable time, possibly many days.” Given that Coffee was discussing highly resistive solid particles rather than highly resistive liquid droplets and given that a liquid spreads on a surface more than a solid (i.e. higher surface area of contact between the charged particle and the object's surface), DI water should remain substantially charged for significantly less than “days,” however some embodiments of the present design require that the charge in the pretreatment material must substantially hold on the object's surface for about seconds or minutes rather than days (known as maximum temporal displacement).

Further DI water is easy and inexpensive to obtain and store. With a commercially available DI water filtration system, DI water can be created and stored in a tank for later use or created in situ from tap, ground or well water. Because of its purity (i.e. lack of suspended solids or minerals), DI water can be directly charged and atomized using relatively inexpensive, electrically charged, metallic, fine-mist spray nozzles with very small orifices coupled with a high-pressure, fluid pump without clogging the nozzles.

Such nozzles are commercially available. Several examples are the hydraulic atomizing spray nozzles from Spraying System Co. Also, it has been found that DI water may nonetheless contain a relatively small density of ions, electrolytes, minerals or other particles and still serve the purposes of DI water in one or more embodiments of the present design. As long as the critical parameters are met in some embodiments of the present design, various types of pretreatment material (or first material) can be used and various methods and systems can be used for dividing or atomizing, charging or emitting the pretreatment material in some embodiments of the present design without adversely deviating or violating one or more of the three criteria set forth above.

In some embodiments of the present design, the pretreatment material (or first material) or the treatment material (or second material) can be liquid, solid or gas, which is encapsulated in a material that may more readily acquires electrical charge, acquires a larger CMR or dissipates charge less quickly. There are a number of prior encapsulation technologies, which can be used in some embodiments of the present design, including without limitation aqueous polyurethane dispersions, polyuria dispersion, melamine-formaldehyde dispersions, poly(meth)acrylate dispersions, ureaformaldehyde dispersions, proteins (lecithin, legumin, gelatin and albumin as examples), polysaccharides (dextrin, starch, gums, chitosan and alginates as examples), fats, liposomes, biopolymers, co-polymers such as poly(lactic-co-glycolic acid), micelles, organogels, dendrimers, solid nanoparticles, polymetric nanoparticles, emulsion based systems and metal-organic particles. In some embodiments of the present design, the encapsulated material in the core may be solid, liquid or gas. A number of microencapsulation techniques have been developed, and a wide variety of them are used extensively in the graphic arts and pharmaceutical industries. Aromatic isocyanates are used in agricultural applications with either a polyamine crosslinker (Beestman, U.S. Pat. No. 4,280,833) or another aromatic isocyanate that is hydrolyzed in situ to produce the amine (Scher, U.S. Pat. No. 4,643,764). Further, Seitz et al. in U.S. Pat. No. 5,925,595 discloses a microencapsulation for agricultural chemicals, which has a more controlled release. In some embodiments of the present design, including agriculture, the first material can be a microencapsulated agricultural chemical, which will more readily acquire and hold charge and permit improved deposition efficiency of a second material, which is either encapsulated or exposed. As one example, Warrant™ by Monsanto Company is an encapsulated herbicide for weed control of soybeans and cotton.

This Stage 1 of some embodiments of the present design suffers from the same problems of variability of deposition efficiency and the Image-Charge Penalty as previous designs; however, in one or more embodiments of the present design, the pretreatment material (or first material) is environmentally benign and inexpensive compared to the treatment material (or second material). Therefore, in one or more embodiments of the present design, overspray or inefficient deposition of the pretreatment material (or first material) in this Stage 1 does not produce the deleterious effects on cost and the environment but still serves one of its fundamental purposes of coating the object's surface with a charged pretreatment material (or first material), which remains on the surface of the object during the time delay 524.

In some embodiments of the present design, a substantial portion of the charge of the pretreatment material (or first material) that is coated on the object's surface must remain on the object's surface during the time delay 524, which can be described as a minimum temporal displacement and a maximum temporal displacement. This minimum temporal displacement is the minimum required delay between ending Stage 1 and beginning Stage 2, and the maximum temporal displacement is the maximum allowed delay between the end of Stage 1 and beginning of Stage 2. The time delay 524 is partly intentional and party inadvertent in some embodiments of the present design. First, in some embodiments of the present design, there must be sufficient time delay 524 for substantially all of the pretreatment material (or first material) to settle onto the object from free space before the opposite-polarity charged treatment material (or second material) is sprayed into the same free space, else the opposite-polarity charged particles (pretreatment material and treatment material) may combine in free space, neutralize before being deposited on the object (if deposited at all) and thus undermine one of the fundamental purposes of electrostatic deposition (i.e. increase deposition probability or efficiency and consistency).

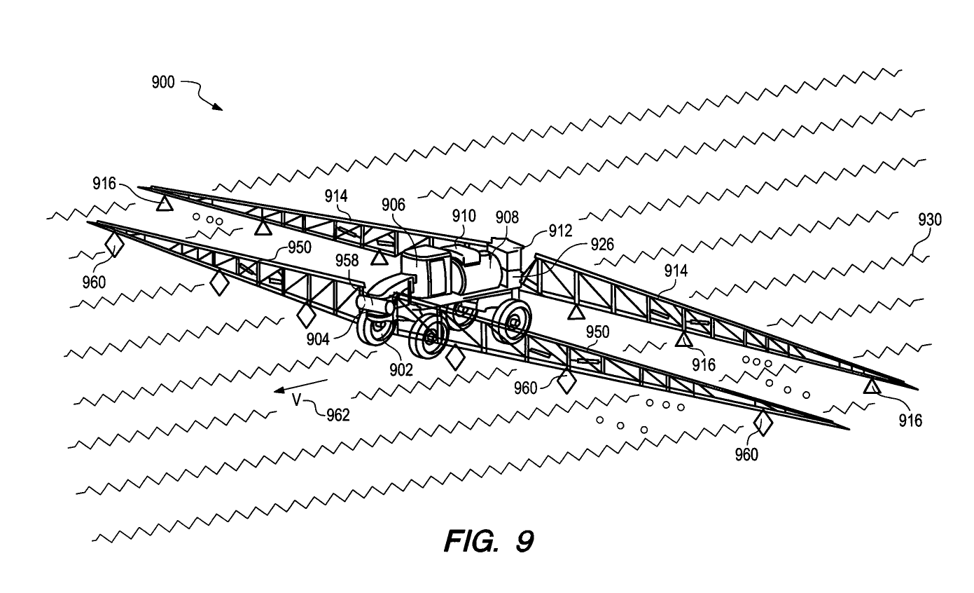

In one or more embodiments of the present design, a minimum temporal displacement is the time between (i) ending of most or all of the first material exiting the first nozzle and entering free space and (ii) starting the second material exiting the second nozzle and entering the free space, and this minimum temporal displacement can be a very short period of time so long as most or all of the first material in free space does not electrically interact and combine with the second material in the same free space. For example, which is more fully described in FIG. 9 below, in one or more embodiments of the present design, in field agricultural applications using a terrestrial sprayer moving linearly down an agricultural field at a substantially fixed velocity, the Stage 1 (or pretreatment application) must be sufficiently far away from the Stage 2 (or treatment or pesticide application) to prevent combination of the pretreatment and treatment materials and charge neutralization of the pretreatment and treatment materials in the time between the front boom passing over the object and the back boom passing over the same object. Second in some embodiments of the present design, a time delay 524 is needed after the Stage 1 process to set up and initiate the Stage 2 process, known as a maximum temporal displacement. As one example, which is more fully described with respect to FIG. 9 below, in one or more embodiments of the present design, depending on the separation of the front booms from the back booms, the finite speed of terrestrial sprayers (about 5-15 km/hr as one example) results in a time delay of up to about 5 seconds between the end of the Stage 1 process and beginning of the Stage 2 process for a given object. Therefore, for some embodiments of present design, agriculture as one example, which is described in FIG. 9 below, a substantial portion of the charge of the pretreatment material that is coated on the object's surface must remain on the object's surface during the time delay 524, for a maximum temporal displacement of about 5 seconds. In some embodiments of the present design, the maximum temporal displacement could be up to about one minute, because of human control of the system or the specific structure of the embodiment. In some embodiments of the present design where one system applies the first material in Stage 1 and then later a second system applies the second material in Stage 2, the maximum temporal displacement could be hours.

At the end of Stage 1 of some embodiments of the present design, the object is coated with the charged pretreatment material (or first material). At this point any similar-polarity charged material or opposite-polarity charged material near the object will experience much stronger electrical repulsion or attraction respectively to the charged coating on the object than the object itself, as is shown in the literature. These are two features of some embodiments of the present design—the attractive force between the charged treatment material and the opposite-polarity charged coating on the object will be stronger and more consistent than the attractive force of the charged material to the grounded object in prior designs. This means that some embodiments of the present design will result in a significantly increased and more consistent deposition probability or efficiency of treatment material on the object compared to known designs. If the maximum temporal displacement is relatively long, the pretreatment material (or first material) as well as the method and system for atomizing and charging the first material must be chosen such that a substantial amount of the charge from the first material remains on the object during this maximum temporal displacement.

In FIG. 5, Stage 2 (or Treatment Stage) 530 of some embodiments of the present design begin with injecting the treatment material (or second material) into the nozzle 532. Then, the treatment material is then divided (including without limitation atomized or pulverized) 534 into droplets or small particles. The divided or atomized treatment material is then charged 536 using one of several means—including without limitation corona ionization charging, induction charging, or direct charging to name a few. In some embodiments of the present design, the polarity of charge of the treatment material in Stage 2 is opposite to the polarity of charge of the pretreatment material in Stage 1. The charged treatment material is then ejected 538 from the nozzle assembly into free space (including air) by force (including pneumatic), preferably towards the object. Now in free space, the divided or atomized, charged treatment material experiences a strong electrostatic attractive force 540 towards the opposite-polarity charged pretreatment material that is coating the object. As noted above and in FIG. 1 and FIG. 2, this force is directly proportional to (i) the amount of charge on the treatment material droplet or particle and (ii) the amount of charge on the pretreatment material coating the object's surface or directly on the object's surface and inversely proportional to the square of the distance between the treatment material droplet or particle and the object's surface, which means that the force increases substantially as treatment material droplet approaches the object to the point where the electrostatic force of attraction 540 is significantly greater than the other forces 542, including gravity, turbulence from wind, turbulence from movement of the electrostatic deposition system and space-charge repulsion of like-polarity charged droplets of treatment material, to the point where the droplet of treatment material attaches 544 to the surface of the object 546.

The force of attraction between the charged treatment material and the opposite-polarity charged pretreatment material coating the object's surface or directly on the object's surface is up to four times more than the force of attraction between the material and the object described in FIG. 3 and FIG. 4 above for the same CMR, mass and distance from the object. Further, because the pretreatment material is substantially uniformly and consistently charged and coated on the object's surface or directly on the object's surface, especially compared to the inconsistent electrical characteristics of the object itself, the force of attraction between the treatment material and the opposite-polarity charged pretreatment material coating the object's surface or directly on the object's surface is more consistent than the force of attraction between the material and the object described in FIG. 3 and FIG. 4 above. This increased and more consistent force of attraction in some embodiments of the present design result in increased deposition probability or efficiency and consistency when compared to prior designs. Finally, in some embodiments of the present design, when deposited, the charged pretreatment material combines with the opposite-polarity charged treatment material on the surface of the object or directly on the object's surface, wholly or partially neutralizing the opposite charges.

In some embodiments of the present design, the nozzle in Stage 2 532 may be the same nozzle in Stage 1 504 with the polarity of the electrostatic charging system manually or automatically reversed or including a valve to manually or automatically switch between pretreatment material and treatment material or pneumatic inputs when switching from Stage 1 to Stage 2 or vice versa.

There are many systems, apparatuses and methods for electrostatic deposition, and although some of the steps described in FIG. 5 may be switched with other steps or occur simultaneously with other steps, the general process is the same for all systems and methods. As one example, induction charging requires that the material be divided or atomized substantially simultaneously during the highest induction field intensity, which means that the steps of atomizing and charging occur substantially simultaneously. Similarities and differences in these attributes do not detract from the scope of the present design.

Also, the atomization 506 and charging 508 methods of Stage 1 can be similar or different from the atomization 534 and charging 536 methods of Stage 2. Although in some embodiments of the present design, a start 502 and end 548 are shown on this process flow chart, the described processes 500, 524 and 530 are continual processes where particles or droplets of pretreatment material are continually divided or atomized, charged, emitted and deposited on the object or series of objects 500, the time delay 524 is continual, and particles or droplets of treatment material are then continually divided or atomized, charged, emitted and deposited on the object or series of objects 530. Further, in some embodiments of the present design, although the processes 500, 524 and 530 describe only one droplet or particle of pretreatment material being divided or atomized, charged, emitted and deposited on the object or series of objects 500 and only one particle or droplet of treatment material being divided or atomized, charged, emitted and deposited on the object or series of objects 520, numerous particles or droplets of pretreatment material are being divided or atomized, charged, emitted and deposited on the object simultaneously and serially 500, and numerous particles or droplets of treatment material are being divided or atomized, charged, emitted and deposited on the object simultaneously and serially 520, with time delays 524 possibly between each one.

As long as the three critical parameters discussed above are met in some embodiments of the present design, various types of treatment material can be used and various methods and systems for dividing or atomizing, charging or emitting the treatment material in some embodiments of the present design without adversely affecting one of the fundamental purposes of this Stage 2.

Another problem with single-stage, single-polarity electrostatic deposition of treatment material on an object is that for some applications, especially some agricultural applications, the treatment material is deposited inconsistently on different parts of an object. For example, Law in “Handbook of Electrostatic Processes,” Marcel Dekker, Inc., 1995, p. 415 states “a major challenge [of electrostatic deposition] is penetration of charged sprays into the electrostatically shielded interior regions of agricultural crops typically ranging from ¼ to 2 m in extent.” In one or more embodiments of the present design, the pretreatment material (or first material) is selectively deposited on certain portions of the surface of the object to facilitate selective attraction and deposition of treatment material (or second material) on the same or inverse portions of the surface of the object. The atomized and charged pretreatment material is deposited 518 (either through spray direction, momentum or force, changing or modulating the CMR of the pretreatment material or otherwise) on predetermined parts of the object, which results in a larger space charge density (Coulombs/cm²) on the predetermined parts of the object relative to the other parts of the object and the ground.

In some embodiments of the present design, the selective deposition of charged pretreatment material on an object's surface can accomplish one or more of several goals:
The pretreatment material can be sprayed by aerodynamic or hydraulic force or momentum (or otherwise) intentionally on certain parts of the object. For example, lower parts of an agricultural plant may experience greater incidence of disease or greater infestation of pests. Therefore, in some embodiments of the present design, the charged, divided or atomized pretreatment material (or first material) can be intentionally sprayed on the lower portions of the plant so that when the opposite polarity charged, divided or atomized treatment material (or second material) (fungicide or insecticide respectively, in the above example of some embodiments of the present design) is sprayed, it will experience a stronger attraction and increased deposition on the lower portions of the plant. Conversely and following the same example, in some embodiments of the present design, the charged, divided or atomized pretreatment material can be intentionally sprayed on the top of plant so that when the like-polarity charged, divided or atomized treatment material (or second material) is sprayed, it will experience a strong repulsion from the top of the plant and preferentially to the bottom of the plant.
Literature in this area indicates that reducing the CMR of material can facilitate deposition on certain portions of the object. For example, reducing the CMR of material can aid in penetration into larger canopies of agricultural plants. In some embodiments of the present design, lowering or modulating the CMR of the pretreatment material (or first material) can aid in deposition of pretreatment material deeper into larger plant canopies (i.e. large plants and trees), which will aid in deposition of treatment materials (pesticides) (or second material) deeper into the canopy of larger plants without materially affecting the CMR of the treatment material (or second material) and its deposition efficiency.
As noted above in FIG. 4, certain objects, especially agricultural plants, have less-than-ideal electrical characteristics for electrostatic deposition and have distributed resistances and capacitances, but it is noted above that this is a first-order approximation. In fact, distressed or diseased leaves or branches can have different electrical characteristics (including resistance, capacitance or relative permittivity) than other portions of the plant or tree. Further, within a single leaf, stem or branch, distressed or diseased portions (including edges, stripes or spots) of a leaf can have different electrical characteristics (including resistance, capacitance or relative permittivity) than other healthier portions of the same leaf or plant. In some embodiments of the present design, proper selection of pretreatment material or proper charging, CMR (including modulating or changing the CMR), dividing or atomization or emitting or spraying pretreatment material will result in increased deposition of pretreatment material on theses distressed or diseased portions of the plant, stems, branches or leaves. Then in some embodiments of the present design, the opposite-polarity charged, divided or atomized treatment material (or second material) (pesticides as one example) will selectively experience a stronger attraction to and increased deposition on the distressed portions of the plant, stems, branches or leaves than the healthy portions of the plant. Conversely and following the same example, in some embodiments of the present design proper selection of pretreatment material or proper charging, CMR (including modulating or changing CMR), dividing or atomizing or emitting or spraying pretreatment material will result in the charged, divided or atomized pretreatment material intentionally deposited preferentially on the healthy portions of leaf or plant versus the distressed or diseased portions of the leaf or plant so that when the like-polarity charged, atomized treatment material (or second material) (pesticide as one example) is sprayed or emitted, it will experience a strong repulsion from the healthy portions of the plant or leaf and preferentially to the distressed or diseased portions of the plant or leaf.
In application of herbicides to kill weeds, it is preferential to deposit as much of the herbicide as possible on the weeds and as little as possible on the agricultural plant. For various reasons, weeds exhibit different electrical characteristics (including resistance, capacitance, relative permittivity or ground connection) than the agricultural plant. For example, larger plants with heavy canopies, such as corn, have different electrical characteristics than waterhemp (one of the biggest weed problems for corn) because of the vastly different structural, physical and morphological characteristics between corn and waterhemp. In some embodiments of the present design, proper selection of pretreatment material or proper charging, CMR, atomization or spraying of pretreatment material will result in increased deposition of pretreatment material on the weeds versus the agricultural plant. Then, in some embodiments of the present design, the oppositely charged, atomized treatment material (or second material) (herbicides in the present example) will selectively experience a stronger attraction and increased deposition on the weeds versus the agricultural plant. Conversely and following the same example, in some embodiments of the present design, the charged, atomized pretreatment material can be intentionally sprayed on the agricultural plant versus the weeds so that when the like-charged, atomized treatment material (or second material) (herbicide in the present example) is sprayed, it will experience a strong repulsion from the agricultural plant and preferentially to the weeds.
In some embodiments of the present design, in application of insecticides to kill or deter insects, mites, nematodes, or small animals, it is preferential to deposit as much of the insecticide on the pest or on the portions of the plant where the pests reside and as little as possible on the whole agricultural plant. For various reasons, insects, mites, nematodes and small animals can exhibit different electrical characteristics (including resistance, capacitance, relative permittivity or ground connection) than the agricultural plant. In some embodiments of the present design, proper selection of pretreatment material or proper charging, CMR (including modulating or changing the CMR), dividing or atomizing or emitting or spraying pretreatment material will result in increased deposition of pretreatment material on the pests or where the pests reside versus the agricultural plant as a whole. Then, in some embodiments of the present design, the opposite-polarity charged, divided or atomized treatment material (or second material) (insecticide as one example) will selectively experience a stronger attraction and increased deposition on the pests, the part of the ground or part of the agricultural plant where the pests reside versus the agricultural plant as a whole. Conversely and following the same example, in some embodiments of the present design, the charged, divided or atomized pretreatment material can be intentionally sprayed on the agricultural plant or ground versus the pests so that when the like-polarity charged, atomized treatment material (insecticide as one example) is emitted or sprayed, it will experience a strong repulsion from the agricultural plant or ground and deposit preferentially on the pests, the part of the ground or part of the agricultural plant where the pests reside versus the agricultural plant as a whole.

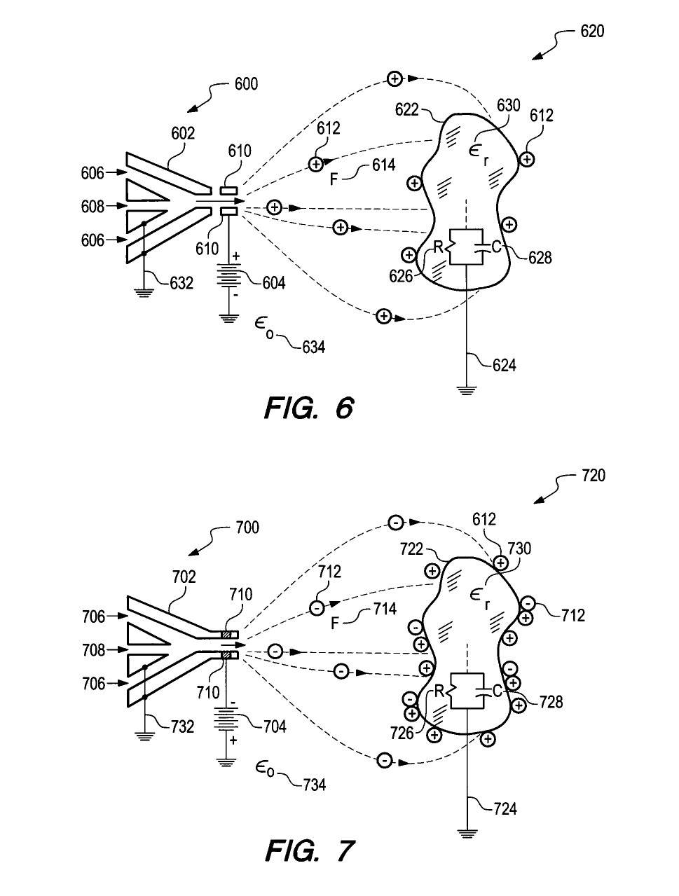

FIG. 6 (Stage 1) and FIG. 7 (Stage 2) are the functional diagrams describing some embodiments of the present design, which is described generally above in the process flows in FIG. 5.

FIG. 6 describes Stage 1 (or Pretreatment Stage) of some embodiments of the present design, comprising generally dividing or atomizing pretreatment material (or first material) 612, charging the pretreatment material 612 and depositing the pretreatment material 612 on the object 620. The electrostatic nozzle 600 is a cutout view of the electrostatic direct-contact type nozzle, including atomizer, charger and emitter, which is one type of atomizer and charger for the pretreatment material of some embodiments of the present design (DI water as one example). One of the fundamental purposes of Stage 1 is to coat the surface of the object 622 with charged pretreatment material 612. More specifically, in some embodiments of the present design, the pretreatment material 612 is injected into the nozzle 600 through the nozzle input orifice 608 through various means, including hydraulic pressure, pneumatic pressure, gravity or suction.

The pretreatment material 612 is atomized by one or more energy inputs 606 that break up or shear the pretreatment material into small droplets, preferably less than about 100 micrometers, in some embodiments of the present design. In some embodiments of the present design, pressurized air is injected into the inputs 606, and the structure of the emitter apparatus 602 combine with the pressurized air's and pretreatment material's movement through the nozzle 600 to atomize the pretreatment material 612. The emitter apparatus 602 and pretreatment material are at substantially ground potential 632 at this point, in some embodiments of the present design. Upon ejection or sprayed from the emitter apparatus 602, the atomized pretreatment material 612 is subject to charge and ionization created by the high voltage potential 604 through direct-contact ionization (in some embodiments of the present design) by direct contact between the charged output 610 and the pretreatment material 612, and the atomized pretreatment material droplets or particles 612 are thus charged with positive charge, in some embodiments of the present design. The amount of charge acquired per unit mass determines its CMR. The charged pretreatment material 612 is then emitted, ejected or sprayed from the emitter apparatus 602 at an initial force or momentum and direction into free space 634 (air as one example) by force (air-assisted pressure as one example) or momentum, preferentially towards the object 620, in some embodiments of the present design. In free space 634, the divided or atomized, charged pretreatment material 612 experiences an attractive electrostatic force 614 towards the grounded object 620, in some embodiments of the present design. The divided or atomized, charged pretreatment material 612 may experience one or more additional forces, including one or more of these five additional forces—(i) gravity, (ii) turbulence from wind, (iii) turbulence from movement of the electrostatic deposition system, (iv) force or momentum from ejection from the emitter apparatus 602 and (v) space-charge repulsion of like-polarity charged droplets of pretreatment material 612 in free space 634 and deposited on the object's surface 622. For simplicity, these five additional forces are not shown in FIG. 6. One of the goals of this Stage 1 of electrostatic deposition, in some embodiments of the present design, is that when the electrostatic force of attraction 614 is significantly greater than the other additional forces, the droplet or particle of pretreatment material 612 accelerates towards the object 620 and attaches to the surface of the object 622. However, in addition to or in conjunction with one or more of the five disruptive forces mentioned above, one or more of several circumstances can cause the object material droplet 612 to fail to accelerate to and attach to the object's surface 622, in some embodiments of the present design, thereby reducing the deposition probability or efficiency:
if the CMR of the pretreatment material droplet or particle 612 is too low, reducing the attractive force 614 compared to one or more of the additional forces,
if one or more of the additional forces are significantly stronger than the electrostatic attractive force 614 between the pretreatment material particle or droplet 612 and the object 620;
if the pretreatment material droplet or particle 612 is emitted, ejected or sprayed from the emitter apparatus 602 at the wrong trajectory or momentum; or
if the object 620 exhibits characteristics (including finite resistance R 626, finite capacitance C 628, finite relative permittivity εᵣ 630 or poor ground potential 624) that are less than ideal (i.e. zero resistance R 626 and capacitance C 628, infinite relative permittivity εᵣ 630, and perfect ground potential 624) thereby reducing the force of attraction 614.

This Stage 1, in some embodiments of the present design, may suffer from the same problems of variability of deposition efficiency and the Image-Charge Penalty as described in FIG. 3 and FIG. 4 above; however, in some embodiments of the present design, the pretreatment material (including DI water) is environmentally benign and inexpensive compared to the treatment material (or second material), which will be deposited in Stage 2 (or Treatment Stage). Therefore, in some embodiments of the present design, overspray or inefficient deposition of the pretreatment material (DI water as one example) in Stage 1 does not produce the deleterious effects on cost and the environment but still serves its purpose of coating the object's surface with a charged pretreatment material, which may remain on the surface of the object during the time delay 524.

FIG. 6 shows a plurality of droplets or particles of positive-polarity charged treatment material 612 in free space 634 after ejection from the emitter apparatus 602 (both simultaneously and serially), and each droplet or particle 612 exhibits independent force 614 (except for mutual repulsion) and acceleration to different parts of the object's surface 622, which results naturally from the unique parameters of each droplet or particle of material 612, including without limitation the following:
the additional forces described above on each droplet or particle 612;
droplet's or particle's 612 size (or density) and mass, which factor into the other forces, including gravity, wind, and turbulence;
droplet's or particle's 612 CMR, which is a factor in the electrostatic force 614 as well as the repulsive force of like-polarity charged particles in free space 634 and on the object's surface 622;
time of exit of the droplet or particle 612 relative to movement of the nozzle 600 over the object (if any);
trajectory or momentum of exit of the droplet or particle 612 from the emitter apparatus 602, especially relative to the object 620;
space-charge repulsion of like-polarity charged droplets or particles 612 in free space 634 from other like-polarity charged droplets or particles 612 in free space 634 and on the object's surface 622;
possible back-corona repulsion of the droplet or particle 612 from the object 620 resulting from sharp edges on the object's surface 622 causing like-polarity charged ion or particle discharge into free space 634;
possible charge neutrality of the droplet or particle 612 in free space 634 combining with opposite-polarity charged ions or particles emitting into free space 634 from sharp edges on the object's surface 622; and
localized electrical differences (including resistance, capacitance, relative permittivity or ground connection) of different portions of the object 620.

In some embodiments of the present design, a substantial amount of the charge of the pretreatment material 612 that is coated on the object's surface 622 may remain on the object's surface 622 or a substantial amount of the charge may be transferred to and remain directly on the object's surface 622 during the time delay 524.

In some embodiments of the present design, at the end of Stage 1, the object's surface 622 is coated with the charged pretreatment material 612. At this point any similar-polarity charged object or opposite-polarity charged object near the object's surface 622 will experience stronger electrostatic repulsion or attraction respectively to the charged coating on object's surface or directly on the object's surface 622 than the object 620 itself. These are two features of some embodiments of the present design—the attractive force between the charged treatment material (or second material) and the opposite-polarity charged coating (or first material) on the object or directly on the object's surface will be stronger and more consistent than the strength and consistency the attractive force of the charged treatment material to the grounded object, as shown in the literature. This means that in one or more embodiments of the present design, an increased and more consistent deposition efficiency of treatment material on the object results when compared to prior designs.

As stated above, there are many systems and methods for single-stage electrostatic deposition, which may be used in this Stage 1 (or Pretreatment Stage) without adversely affecting the inventive nature of invention or embodiments disclosed; and although some of the steps described in FIG. 6 may be switched with other steps or occur simultaneously with other steps, the general processes (atomization, charging and spraying) are the same for all systems and methods. As one example, induction charging requires that the treatment material be atomized simultaneously during the highest induction field intensity. As another example, atomization and charging of the pretreatment material 612 occur substantially simultaneously in induction charging. One skilled in the art will understand and appreciate the differences.

Some embodiments of the present design do not depend on the particular methods or systems of dividing or atomizing, charging or deposition; although some methods or systems work better than others in some embodiments of the present design. As examples, electrodynamic charging and direct charging work for pretreatment materials that have high resistivity, and induction charging is one example of charging pretreatment materials that have higher conductivity, although the CMR varies from one application or system to the next for a given material. Conversely, corona charging may be applicable to pretreatment material, which is mostly independent of resistivity of the pretreatment material, although the CMR may be reduced compared to other applications. In some embodiments of the present design, the result of Stage 1 is that the object's surface 622 is coated with charged pretreatment material 612, which positive-polarity charged coating 612 is shown in FIG. 7.

FIG. 7 describes Stage 2 (or Treatment Stage) of some embodiments of the present design, comprising generally dividing or atomizing treatment material (or second material) 712, charging the treatment material 712 and depositing the treatment material 712 on the object 720 which is the same as object 620, and in some embodiments of the present design, with the same or substantially the same resistance R 626, capacitance C 628 and relative permittivity εᵣ 630 as in FIG. 6 for Stage 1. The electrostatic nozzle 700 is a cutout view of the electrostatic induction-type nozzle, including atomizer, charger and emitter. Because the object's surface 722 is coated with positive-polarity charged pretreatment material (or first material) 612 in some embodiments of the present design, the negatively charged treatment material 712 will experience up to four times increased attractive force 714 between the charged treatment material 712 and the object's surface 722 compared to previous designs.

Further, in some embodiments of the present design, the less-than-ideal and inconsistent electrical characteristics of the inside of the object 720 (including resistance R 726, capacitance C 728 and permittivity εᵣ 730) are partly or mostly shielded by the charged pretreatment material 612 on the object's surface 722; and therefore the force 714 for a given distance between the pretreatment material 712 and the object's surface 722 and CMR will be more consistent, resulting in a more consistent deposition efficiency. More specifically, in some embodiments of the present design, the treatment material 712 is injected into the nozzle 700 through the nozzle input orifice 708, by hydraulic force as one example. The treatment material 712 is atomized by one or more energy inputs 706 that break up or shear the treatment material into small droplets, usually less than about 100 micrometers, in some embodiments of the present design. In some embodiments of the present design, pressurized air is injected into the inputs 706, and the structure of the emitter apparatus 702 combines with the pressurized air's and treatment material's movement through the nozzle 700 to atomize the treatment material 712. The emitter apparatus 702 and treatment material 712 are substantially at ground potential at this point, in some embodiments of the present design. Upon ejection or sprayed from the emitter apparatus 702, the atomized treatment material 712 is subject to ions created by the high negative voltage potential 704 and induction annular ring 710, which circumscribes the exit orifice of the emitter apparatus 702, and the atomized treatment material droplets 712 acquire some of the ions and are thus negatively charged, which is opposite-polarity charged from the charge of the pretreatment material 612 coating the object's surface 722. In some embodiments of the present design, the polarity of charge of the pretreatment material 612 can be negative, and the polarity of charge of the treatment material 712 can be positive. The charged treatment material 712 is then ejected from the nozzle system 702 at an initial force or momentum and direction into free space (air as one example) by force (air-assisted pressure as one example) or momentum, usually towards the object 720 in some embodiments of the present design. Now in free space 734, the atomized, charged treatment material 712 experiences an attractive electrostatic force 714 towards the opposite-polarity charged pretreatment material 612 coating the object's surface 722, which as noted above is up to four times stronger force than the force of attraction 414 shown in FIG. 4 for similar CMR, and distance of the material droplet or particle from the object's surface.

In some embodiments of the present design, the divided or atomized, charged treatment material 712 experiences one or more additional forces, including one or more of these five additional forces—(i) gravity, (ii) turbulence from wind, (iii) turbulence from movement of the electrostatic deposition system, (iv) force or momentum from ejection from the emitter apparatus 702 and (v) space-charge repulsion of like-polarity charged droplets of treatment material 712 in free space 734. For simplicity, these additional forces are not shown in FIG. 7. One of the primary goals of electrostatic deposition is that when the electrostatic force of attraction 714 towards the object's surface 720 is significantly greater than the other additional forces, the droplet or particle of treatment material 712 accelerates towards the object's surface 722 and attaches to the object's surface 722. Because in some embodiments of the present design, the force 714 is greater in the present design than in the force 414 shown in FIG. 4, representing previous designs, the additional forces—(i) gravity, (ii) turbulence from wind, (iii) turbulence from movement of the electrostatic deposition system, (iv) force from ejection from the emitter apparatus 702 and (v) space-charge repulsion of like-charged droplets of treatment material 712 in free space 734 have a diminished effect on the treatment material 712, resulting in increased deposition efficiency and consistency.

FIG. 7 shows a plurality of droplets or particles of negative-polarity charged treatment material 712 in free space 734 after ejection from the emitter apparatus 702 (both simultaneously and serially), and each droplet or particle 712 exhibits independent force 714 (except for mutual repulsion) and acceleration to different parts of the object's surface 722, which results naturally from the unique parameters of each droplet or particle of material 712, including without limitation the following:
the additional forces described above on each droplet or particle 712;
droplet's or particle's 712 size (or density) and mass, which factor into the other forces, including gravity, wind, and turbulence;
droplet's or particle's 712 CMR, which is a factor in the electrostatic force 714 as well as the repulsive force of like-polarity charged particles in free space 734 and on the object's surface 722;
time of exit of the droplet 712 relative to movement of the nozzle 700 over the object (if any);
trajectory or momentum of exit of the droplet or particle 712 from the emitter apparatus 702, especially relative to the object 720;
space-charge repulsion of like-polarity charged droplets or particles 712 in free space 734 from other like-polarity charged droplets or particles 712 in free space 734 and on the object's surface 722, which have not neutralized with opposite-polarity charged first material 612;
possible back-corona repulsion of the droplet or particle 712, which has not neutralized with opposite-polarity charged first material 612, from the object 720 resulting from sharp edges on the object's surface 722 causing like-polarity charged ion or particle discharge into free space 734;
possible charge neutrality of the droplet or particle 712 in free space 734 combining with opposite-polarity charged ions or particles emitting into free space 734 from sharp edges or otherwise on the object's surface 722;
selective attractive force of the droplet or particle 712 to specific parts of the object's surface 722 resulting from a larger concentration of opposite polarity charged pretreatment material 622 (either intentional or inadvertent) on the specific parts of the object's surface 722;
selective repulsive force of the droplet or particle 712 from specific parts of the object's surface 722 resulting from a larger concentration of like polarity charged pretreatment material 622 (either intentional or inadvertent) on the specific parts of the object's surface 722; and
localized electrical differences (including resistance, capacitance, relative permittivity or ground connection) of different portions of the object 720, which should be reduced compared to Stage 1 or prior designs, because of the coating of opposite-polarity charged first material 622 on the target's surface 722.

In some embodiments of the present design, treatment material 712 can come in many viscosities and levels of dissolved solids, and treatment material 712 can be a powder. In addition, treatment material 712 can be liquid or powdered solid and diluted in a liquid that is the same as or different from the dilution liquid of the pretreatment material 612. Further in some embodiments of the present design, pretreatment material 612 can come in many viscosities and levels of dissolved solids or even a powder, so long as the pretreatment material 612 meets the following criteria:
Acquires charge from an electrostatic charging system 600, either before spraying, contemporaneously or after spraying;
Attaches to the surface of the object 622; and
Holds all or a portion of the charge for a considerable amount of time or shares and holds all or a portion of the charge with the object's surface 622.

In some embodiments of the present design, the electrical connections of the material streams 608 or 708 (via ground connections 632 and 732 respectively) or the voltage sources 604 or 704 to ground are not required to be perfect and can be substantially electrically connected to ground. As one example, in some agricultural applications, a substantial electrical connection to earth ground can be obtained by dragging a metal object (metal chain as one example) under or behind the system to the earth's surface. Further, in some embodiments of the present design, it is not required that the connection to the ground be an earth ground but rather can be a common voltage reference that is either floating or tied substantially to some other voltage reference other than earth ground.

What are not shown in FIG. 6 and FIG. 7 are one or more reservoirs, which hold one or more of the first materials and one or more of the second materials respectively entering the input orifices 608 and 708. These input orifices 608 and 708 are connected to one or more of the reservoirs, and in some embodiments of the present design, one or more of the first materials and one or more of the second materials enter the input orifices 608 and 708 respectively and through the nozzles 600 and 700 respectively via one or more pumps to force one or more of the first materials or second materials into or through the nozzles 600 and 700 respectively.

In some embodiments of the present design, the nozzles 600 and 700 can come in many forms and can be described generally as a nozzle, orifice, distribution system, sprayer, outlet, channel, aperture, exit, egress, release or opening. In some embodiments of the present design, the nozzles 600 and 700 can serve the single purpose of distributing one or more of the first materials or one or more of the second materials respectively or can integrate some of the other functions including atomizing, charging or pumping one or more of the first materials or one or more of the second materials.

In some embodiments of the present design, the first materials or second materials are described or claimed as “one or more” first materials or “one or more” second materials, meaning that the first materials or second materials may be a combination (serially or contemporaneously) or a mixture of a plurality of first materials or a plurality of second materials, which combinations may each (or a subset) have its own reservoirs, pumps, atomizers, chargers or nozzles.

FIGS. 5-7 are provided as exemplary diagrams of electrostatic deposition environments in which embodiments of the present design may be implemented. It should be appreciated that FIGS. 5-7 are only exemplary and are not intended to assert or imply any limitation with regard to the environments in which aspects or embodiments of the disclosed embodiments may be implemented. Many permutations or combinations of the different embodiments can be accomplished in the present design. Many modifications to the depicted environments may be made without departing from the spirit and scope of the present design.

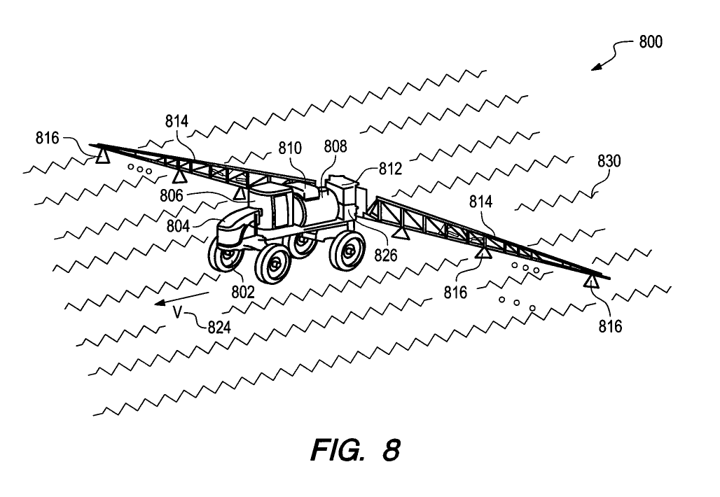

FIG. 8 is a perspective drawing of a typical self-propelled terrestrial sprayer for large-scale agricultural spraying of plant materials (including pesticides, fertilizers etc.).

The terrestrial sprayer 800 can use either conventional spraying or electrostatic spraying, which is described in FIG. 3 and FIG. 4 above. The terrestrial sprayer 800 of prior designs travels along agricultural crops 830 in a field at an average velocity v 824, which is about 5 to 15 km/hr. The purpose of terrestrial sprayer 800 is to spray and deposit plant materials on the field 830, preferably mostly on the diseased portions of the plant for fungicides, the weeds for herbicides and the pests for insecticides. The goal of this prior terrestrial sprayer is to maximize the amount of material deposited on the intended object and minimize overspray or drift of materials deposited onto other portions of the field such as the ground.

As noted above in FIG. 3 and FIG. 4, prior electrostatic spraying of plant materials has improved deposition efficiency in agriculture; however less-than-ideal and differing electrical characteristics of agricultural plants (both interspecies and intraspecies within the same field or under differing environmental conditions) result in less than ideal and inconsistent deposition efficiencies in agricultural applications. This is one of the principal reasons why prior technology has not been broadly adopted in agricultural applications. More specifically, the prior terrestrial sprayer 800 is self-propelled because it contains its own means of perambulation via the wheels 802 and motor and transmission 804. The driver/operator sits in the cabin 806 where the operator can not only move the terrestrial sprayer 800 down the agricultural crops 830 but also operate the motors, switches, valves and actuators for the spraying system. The terrestrial sprayer 800 contains at least one tank 808 for holding either the premixed material to be sprayed or the diluting material (usually water) to be mixed possibly in situ with the concentrated plant material via an induction hopper (not shown).

The induction hopper is a smaller tank that contains only the concentrated plant material and mixes with the diluting liquid (usually water) possibly in situ prior to being pumped down the booms 814 via the piping and valve system to the spray nozzles 816. If no in situ mixing of the plant material and diluting material is used, the diluted plant material in the tank 808 is distributed to the spray nozzles 816 along the spray booms 814 along a piping and valve system via pressure supplied by the hydraulic pump 812. The hydraulic pump 812 can be either powered by the engine or transmission 804 (electrically, hydraulically or mechanically via a “power takeoff” gear attached to the engine and transmission 804) or self-powered. Once distributed to each spray nozzle 816, the plant materials are then ejected under hydraulic or pneumatic pressure from one or more of the nozzles 816 and sprayed by one or more means to the agricultural crops 830. If the terrestrial sprayer 800 provides electrostatic spraying of the plant chemicals, then following the discussion in FIG. 3 and FIG. 4 above, the voltage source 810 and air compressor 826 provide power along the electric and pneumatic distribution means along the booms 814 to the electrostatic nozzles 816. Power for the voltage source 810 or air compressor 826 can be either powered by the engine or transmission 804 (electrically, hydraulically or mechanically via a “power takeoff” gear attached to the engine and transmission 804) or self-powered. The electrostatic spraying at each nozzle 816 then follows the process and descriptions in FIG. 3 and FIG. 4 above for dividing or atomizing, charging or emitting or depositing the plant materials on the agricultural crops 830.

As noted in FIG. 3 and FIG. 4, there are many different configurations for terrestrial sprayers available, both conventional and electrostatic. For example, the high voltage power needed for electrostatic deposition can be generated centrally at the generator 810 and distributed down the booms 814 to each nozzle 816 or can be distributed via lower voltage at the generator 810 or engine 804 and distributed down the booms 814 via the distribution network to each nozzle assembly 816 where the voltage is increased locally.

Additionally, the dividing or atomizing power may be distributed electrically, hydraulically or pneumatically down the booms 814 via distribution network to each nozzle 816 and converted to mechanical power to divide or atomize the diluted plant material via a rotary atomizer (or other atomizing means) at each nozzle 816. Examples of commercially available, self-propelled terrestrial sprayers are the John Deere R4040i, the Horsch PT 280, the Kellands Agribuggy A280, Landquip's CV210, the Condor ClearancePlus, and the Case Patriot® line of terrestrial sprayers. This is just one example of prior systems and methods of spraying plant chemicals. Other prior systems of spraying plant materials include without limitation, tractor-mounted sprayers, tractor pulled sprayers, aerial applications (drones, airplanes and helicopters), handheld applicators, and robot-assisted or robot-driven applicators. Examples of tractor-mounted or tractor-pulled terrestrial sprayers are Unigreen's Campo line of sprayers, Berthoud Ektar tractor-pulled sprayer, John Deere PowrSpray line of tractor-pulled sprayers, and the Tecnoma Tecline R tractor-mounted sprayers.

FIG. 9 represents some embodiments of the present design, which is a perspective view of an agricultural terrestrial sprayer and follows the general inventive steps of FIG. 5. Stage 1 of some embodiments of the present design (shown as 500 in FIG. 5.) is performed by the front booms 950 of the terrestrial sprayer 900. Stage 2 of some embodiments of the present design (shown as 530 in FIG. 5.) is performed by the back booms 914 of the terrestrial sprayer 900. In some embodiments of the present design, the terrestrial sprayer 900 is further described diagrammatically in FIG. 6 and FIG. 7 above. In some embodiments of the present design, the terrestrial sprayer 900 travels along agricultural crops 930 in a field at a velocity v 962 of about 5 to 15 km/hr.

One of the primary purposes of terrestrial sprayer 900 is to spray and deposit plant materials on the field 930, preferably mostly on the diseased portions of the plant for fungicides, the weeds for herbicides and the pests for insecticides. As noted above in FIG. 6 and FIG. 7, some embodiments of the present design of electrostatic spraying of plant materials improves deposition efficiency and consistence over previous systems and methods (both interspecies and intraspecies within the same field or under differing environmental conditions). More specifically in some embodiments of the present design, the terrestrial sprayer 900 is self-propelled because it contains its own means of perambulation via the wheels 902 and motor and transmission 904. In some embodiments of the present design, the driver/operator sits in the cabin 906 where the operator not only moves the terrestrial sprayer 900 down the agricultural crops 930 but also operates the motors, switches, valves and actuators for the front and rear spraying systems. In some embodiments of the present design, the terrestrial sprayer 900 contains at least one tank 908 for holding either the premixed plant materials to be sprayed or the diluting material (water as one example) to be mixed in situ with the concentrated plant materials via an induction hopper (not shown). The induction hopper is a smaller tank that contains only the concentrated plant materials and mixes the plant materials with the diluting liquid (water as one example) in situ prior to being pumped down one or both of the booms 914 or 950 via the piping and valve systems to the nozzles 916 or 960 respectively.

In some embodiments of the present design, if an induction hopper is used for the concentrated plant materials and the plant materials are mixed with the dilution liquid in situ, then only one tank 908 will be needed in the present embodiment because the one tank 908 can be filled with the pretreatment material (or first material) (DI water as one example) for use in Stage 1, which can also be used as the diluting material (same DI water as one example) for Stage 2 (mixing with the concentrated plant material from the induction hopper for treatment material or second material). However, in some embodiments of the present design, if (i) the pesticide material (or second material) is premixed with its diluting liquid or (ii) the first material is not used as a diluting material, adjuvant or additive in the second material, then an additional tank 958 is used to supply pretreatment material (or first material) (DI water as one example) for Stage 1. Recall in FIG. 5 that Stage 1 of some embodiments of the present design sprays or emits charged pretreatment material (DI water as one example) on the agricultural plants and coats the plants' surfaces with an electrical charge. In some embodiments of the present design, the pretreatment material (DI water as one example) in the tank 908 (or 958) is distributed to the spray nozzles 960 along the spray booms 950 along a piping and valve system via hydraulic pressure supplied by the pump 912. In some embodiments of the present design, the pump 912 can be either powered by the engine or transmission 904 (electrically, hydraulically or mechanically via a “power takeoff” gear attached to the engine and transmission 904) or self-powered as just two examples. Once distributed to each spray nozzle 960, the pretreatment material (DI water as one example) is then ejected under hydraulic pressure and sprayed onto the agricultural crops 930, in some embodiments of the present design. In some embodiments of the present design, the voltage source 910 and air compressor 926 provide power along the electric and pneumatic distribution means along the booms 950 to the electrostatic nozzles 960. In some embodiments of the present design, power for the voltage source 910 or air compressor 926 can be either powered by the engine or transmission 904 (electrically, hydraulically or mechanically via a “power takeoff” gear attached to the engine and transmission 904) or self-powered as just two examples. In some embodiments of the present design, the electrostatic spraying at each nozzle 960 then follows the process and descriptions in FIG. 6 above for depositing the pretreatment material (DI water as one example) on the agricultural crops 930.

As noted in FIG. 6, there are many different configurations for electrostatic deposition of pretreatment materials on the crops 930. For example, in some embodiments of the present design, the high voltage power needed for electrostatic deposition can be generated centrally at the generator 910 and distributed down the booms 950 to each nozzle 960 or can be distributed via lower voltage at the generator 910 or engine 904 and distributed down the booms 950 via the distribution network to each nozzle assembly 960 where the voltage is increased locally. Additionally, in some embodiments of the present design, the atomizing power may be distributed electrically, hydraulically or pneumatically down the booms 950 via the distribution network to each nozzle and converted to mechanical power to atomize the pretreatment material (DI water as an example) via a rotary atomizer (or other means) at each nozzle 960. In some embodiments of the present design, as the terrestrial sprayer 900 moves continually through the agricultural field 930 at velocity v 962, the agricultural plants, which are passed over by the front booms 950 and nozzles 960, are sprayed with positive polarity charged pretreatment material (DI water as one example), and the surfaces of the agricultural plants 930 are thus coated with a positive charge.

In some embodiments of the present design, as the terrestrial sprayer moves through the agricultural field 930 (at a velocity v 962 from about 5 to 15 km/hr. as one example), a time delay of up to about 5 seconds (in the example for a terrestrial sprayer of about ˜7 meters' length) results between deposition of the charged pretreatment material (DI water as one example) in Stage 1 on the agricultural plants and initiation of Stage 2 (back boom spraying of the second material). The minimum temporal displacement is not an issue in some embodiments of the present design using terrestrial sprayers because there is sufficient time between the front boom spraying an object and the back boom spraying an object to obviate any material combination of the first material and second material in free space. In some embodiments of the present design, a substantial portion of the charge imparted on the agricultural plants 930 by the charged pretreatment material (DI water as one example) must remain on the surface of the agricultural plants 930 during this time delay (˜5 seconds as one example), which is the maximum temporal displacement in some embodiments of the present design.

In Stage 2 (or Treatment Stage) of some embodiments of the present design of FIG. 9, the plant materials (or treatment material or second material) premixed in the tank 908 (or mixed with the diluting material via the induction hopper) are distributed to the spray nozzles 916 along the spray booms 914 along a piping and valve system via hydraulic pressure supplied by the pump 912. In some embodiments of the present design, the pump 912 can be either powered by the engine or transmission 904 (electrically, hydraulically or mechanically via a “power takeoff” gear attached to the engine and transmission 904) or self-powered as just two examples. Once distributed to each spray nozzle 916, the plant materials are then ejected under hydraulic or pneumatic pressure and sprayed onto the agricultural crops 930, in some embodiments of the present design. The voltage source 910 and air compressor 926 provide power along the electric and pneumatic distribution means along the booms 914 to the nozzles 916, in some embodiments of the present design. In some embodiments of the present design, power for the voltage source 910 (inverted to negative polarity voltage for this Stage 2) or air compressor 926 can be either powered by the engine or transmission 904 (electrically, hydraulically or mechanically via a “power takeoff” gear attached to the engine and transmission 904) or self-powered as just two examples. In some embodiments of the present design, the electrostatic spraying at each nozzle 916 then follows the process and descriptions generally in FIG. 7 above for depositing the negative polarity charged plant materials on the agricultural crops 930.

As noted in FIG. 7, there are many different configurations for electrostatic deposition of treatment materials (or second materials) on the crops 930. For example, in some embodiments of the present design, the high voltage power needed for electrostatic deposition can be generated centrally at the generator 910 and distributed down the booms 914 to each nozzle 916 or can be distributed via lower voltage at the generator 910 or engine 904 and distributed down the booms 914 via the distribution network to each nozzle 916 where the voltage is increased locally. Additionally, in some embodiments of the present design, the atomizing power may be distributed electrically, hydraulically or pneumatically down the booms 914 via distribution network to each nozzle 916 and converted to mechanical power to divide or atomize the plant material via a rotary atomizer (or other means) at each nozzle 916. In some embodiments of the present design, as the terrestrial sprayer 900 moves through the agricultural field 930 at velocity v 962, the result of Stage 2 is that the agricultural plants that are continually passed over by the back booms 914 and nozzles 916 are sprayed with negative-polarity charged second materials. When in free space, the negative-polarity charged pesticide (or second material) droplets or particles, in some embodiments of the present design, experience a strong attraction to the positive-polarity charged surfaces of the agricultural plants 930, resulting in an improved deposition efficiency and consistency of the second materials from the terrestrial sprayer 900 onto the agricultural plants 930.

In some embodiments of the present design, the voltage source 910, air compressor 926, hydraulic pump 912, or possibly even the fluid tank 908 are shared with Stage 1 (positive polarity charged pretreatment material deposition) and Stage 2 (negative polarity charged treatment material deposition). These are just some embodiments of the present design of spraying plant materials on agricultural crops. Other terrestrial and aerial applications methods (including without limitation such as tractor-mounted, tractor-pulled, handheld, robot or drone connected (either in the greenhouse or field), or aerial) can be used with some embodiments of the present design to improve deposition efficiency. One of the salient features of some embodiments of the present design is that although significantly inventive above prior references, some embodiments of the present design can be implemented by a relatively inexpensive, straightforward retrofit of existing terrestrial spraying equipment.

In some embodiments of the present design, the first material is chemically compatible with the second material, meaning that the first material and second material, when on the object's surface do not materially or substantially impair the purpose for the deposition of the second material or first material on the object, if one of the actions of the first material or second material on the object is chemical.

In some embodiments of the present design, the first material is biologically compatible with the second material, meaning that the first material and second material, when on the object's surface do not materially or substantially impair the purpose for the deposition of the second material or first material on the object, if one of the actions of the first material or second material on the object is biological.

Although some of the disclosed embodiments of the present design relate to electrostatic applications of pesticides and other materials to agricultural plants, the present design is not limited to agriculture, but rather some embodiments of the present design are applicable in any circumstance where the object has less-than-ideal or differing electrical characteristics or where selective deposition of treatment materials onto objects is desired, and those skilled in the art will understand and appreciate the expanded scope of the present design. Some embodiments of the present design include, without limitation the following:
Electrostatic coating;
Electrostatic precipitation;
Electrostatic separation;
Electrostatic flocking;
Xerography and printing; and
Nanotechnology.

As examples and in no way limiting the scope of the present invention, treatment materials can be paints and coatings, both liquid and powder, pesticides (herbicides, insecticides and fungicides) for agricultural applications, both outdoor and indoor, and water; and such treatment materials can be diluted in various liquids such as water, deionized water, oils and solvents. Further as examples and in no way limiting the scope of the present invention, pretreatment materials (or first materials) or treatment materials (or second materials) can be either (i) liquids such as water, deionized water (with different levels of resistivity), oils, solvents, powders alone or suspended in such liquids or (ii) one part of multi-part material depositions such a paints and coatings, both liquid and powder, pesticides (herbicides, insecticides and fungicides) and fertilizers for agricultural applications, both outdoor and indoor, and water; and such pretreatment materials and treatment materials can be diluted in various liquids such as water, deionized water, oils and solvents. These changes in the treatment material and pretreatment material do not limit the scope of the present design.

Thus according to one aspect of the present design, there is provided an electrostatic deposition system, comprising a first nozzle with a first output spray angle, at least one first material reservoir coupled to the first nozzle through at least one first passageway, comprising at least one first material path from at least one first reservoir along one first passageway, through the first nozzle and into a first output spray, at least one first voltage supply in electrical contact with at least one first material, wherein one first voltage supply is referenced to at least one first voltage reference, a second nozzle with a second output spray angle, at least one second material reservoir coupled to the second nozzle through at least one second passageway, comprising at least one second material path from at least one second reservoir along one second passageway, through the second nozzle and into a second output spray, and at least one second voltage supply in electrical contact with at least one second material, wherein one second voltage supply is referenced to at least one second voltage references. At least one of the second voltage references has a polarity or sign opposite to at least one of the first voltage references.

According to a second aspect of the present design, there is provided a method of depositing materials on an object. The method comprises charging at least one first material to a charge-to-mass ratio of at least 0.20 milli-Coulombs/kg, emitting or spraying at least one first material away from the first nozzle into free space, wherein at least one of the charged first materials are attracted to and move toward an object under electrostatic attractive forces between at least one of the first materials and the object, and wherein at least one of the charged first materials deposit on the object and impose or maintain an electric charge on the object or at least one of the first materials on the object, charging at least one second material to a charge-to-mass ratio of at least 0.20 milli-Coulombs/kg and opposite polarity to the charge applied to at least one of the first materials, and emitting or spraying at least one of the second materials away from the second nozzle into free space; wherein at least one of the charged second materials are attracted to, move towards and are deposited on the opposite-polarity charged object or first material on the object.

According to a further aspect of the present design, there is provided a system for depositing material on an object. The system comprises a first nozzle configured to charge a first material to a charge-to-mass ratio of at least 0.20 milli-Coulombs/kg and emit at least a portion of charged first material away from the first nozzle, wherein the first material is capable of suspension in free space and attraction to, movement toward and deposition on the object under electrostatic attractive forces, and wherein the first material is capable of coating or imposing an electric charge on the object or first material on the object, and a second nozzle configured to charge a second material to a charge-to-mass ratio of at least 0.20 milli-Coulombs/kg and emit at least a portion of charged second material away from the second nozzle, wherein the second material is capable of suspension in free space and attraction to, movement toward and deposition on the object or the first material coating the object under electrostatic attractive force.

While the present design has been particularly shown and described with reference to some embodiments, it will be understood by those skilled in the art that various changes in form and detail may be made therein without departing from the spirit and scope of the invention.

It will be appreciated that variations of the above disclosed and other features and functions, or alternatives thereof, can be desirably combined into many other different systems or applications. Also that various presently unforeseen or unanticipated alternatives, modifications, variations or improvements therein can be subsequently made by those skilled in the art, which are also intended to be encompassed by the present design. The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. An electrostatic deposition system, comprising:
a first nozzle with a first output spray angle;
at least one first material reservoir coupled to the first nozzle through at least one first passageway, comprising at least one first material path from at least one first reservoir along one first passageway, through the first nozzle and into a first output spray;
at least one first voltage supply in electrical contact with at least one first material, wherein one first voltage supply is referenced to at least one first voltage reference;
a second nozzle with a second output spray angle;
at least one second material reservoir coupled to the second nozzle through at least one second passageway, comprising at least one second material path from at least one second reservoir along one second passageway, through the second nozzle and into a second output spray; and
at least one second voltage supply in electrical contact with at least one second material, wherein one second voltage supply is referenced to at least one second voltage references;
wherein at least one of the second voltage references has a polarity or sign opposite to at least one of the first voltage references.

2. The system of claim 1 wherein the first nozzle and second nozzle are each capable of moving along at least one directions of linear or angular motion with respect to an object, and wherein at least 10% of the second spray angle is capable of overlapping with the first spray angle along at least one of the directions of motion.

3. The system of claim 2 including a structure capable of coupling the first nozzle and second nozzle.

4. The system of claim 1 wherein the first nozzle and second nozzle are each capable of moving along at least one directions of linear or angular motion with respect to an object, and wherein the average normalized electrostatic force of attraction of second material output spray in free space between the second nozzle and the object is greater than 1.5 (kN m²/kg²).

5. The system of claim 1 further comprising at least one atomizer capable of contact with at least one of the first materials or second materials.

6. The system of claim 5, further comprising at least one pump capable of connection to at least one atomizer, wherein each pump is hydraulic, pneumatic, or electrodynamic.

7. The system of claim 1 wherein the first nozzle and second nozzle are each capable of moving along at least one directions of linear or angular motion with respect to an object, and wherein a minimum temporal displacement is capable of existing between the first nozzle capable of depositing at least one of the first materials on the object and the second nozzle capable of depositing at least one of the second materials on the object.

8. A method of depositing materials on an object, comprising:
charging at least one first material to a charge-to-mass ratio of at least 0.20 milli-Coulombs/kg;
emitting or spraying at least one first material away from the first nozzle into free space, wherein at least one of the charged first materials are attracted to and move toward an object under electrostatic attractive forces between at least one of the first materials and the object, and wherein at least one of the charged first materials deposit on the object and impose or maintain an electric charge on the object or at least one of the first materials on the object;
charging at least one second material to a charge-to-mass ratio of at least 0.20 milli-Coulombs/kg and opposite polarity to the charge applied to at least one of the first materials; and
emitting or spraying at least one of the second materials away from the second nozzle into free space; wherein at least one of the charged second materials are attracted to, move towards and are deposited on the opposite-polarity charged object or first material on the object.

9. The method of claim 8 further comprising an additional step of at least one of:
atomizing at least one of the first materials to less than or equal to a spheroidal diameter of 100 micrometers;
atomizing at least one of the first materials comprising, a pulverized or powdered solid suspended in liquid, to less than or equal to 100 micrometers;
atomizing at least one of the second materials to less than or equal to a spheroidal diameter of 100 micrometers; and
atomizing at least one of the second materials, comprising a pulverized or powdered solid suspended in liquid, to less than or equal to 100 micrometers.

10. The method of claim 8 wherein at least one of the first materials are charged, emitted or sprayed, and deposited on predetermined parts of the object such that when at least one of the opposite-polarity charged second materials are charged and emitted or sprayed, at least one of the opposite-polarity charged second materials experience a stronger electrostatic attraction force to the predetermined parts of the object relative to the other parts of the object and the environment surrounding the object.

11. The method of claim 8 wherein at least one of the first materials are charged, emitted or sprayed, and deposited on predetermined parts of the object such that when at least one of the like-polarity charged second materials are charged and emitted or sprayed, at least one of the like-polarity charged second materials experience a stronger electrostatic repulsion force from the predetermined parts of the object.

12. The method of claim 8 wherein at least one of the first materials is the same as, chemically compatible with, or biologically compatible with, at least one of the second materials.

13. The method of claim 8 wherein the first nozzle and second nozzle each move along at least one directions of linear or angular motion with respect to an object, and wherein a minimum temporal displacement is capable of existing between the first nozzle depositing at least one of the first materials on the object and the second nozzle depositing at least one of the second materials on the object.

14. A system for depositing material on an object, comprising:
a first nozzle configured to charge a first material to a charge-to-mass ratio of at least 0.20 milli-Coulombs/kg and emit at least a portion of charged first material away from the first nozzle, wherein the first material is capable of suspension in free space and attraction to, movement toward and deposition on the object under electrostatic attractive forces, and wherein the first material is capable of coating or imposing an electric charge on the object or first material on the object; and
a second nozzle configured to charge a second material to a charge-to-mass ratio of at least 0.20 milli-Coulombs/kg and emit at least a portion of charged second material away from the second nozzle, wherein the second material is capable of suspension in free space and attraction to, movement toward and deposition on the object or the first material coating the object under electrostatic attractive force.

15. The system of claim 14 wherein:
the first material is a liquid wherein the first nozzle is capable of dividing or atomizing the first material to less than or equal to a median spheroidal diameter of 100 micrometers;
the first material is a pulverized or powdered solid with a median size of less than or equal to 100 micrometers;
the first material is a powdered solid suspended in liquid wherein the first nozzle is capable of dividing or atomizing the first material to less than or equal to a median diameter of 100 micrometers;
the second material is a liquid wherein the second nozzle is capable of dividing or atomizing the second material to less than or equal to a median spheroidal diameter of 100 micrometers;
the second material is a pulverized or powdered solid with a median size of less than or equal to 100 micrometers; or
the second material is a powdered solid suspended in liquid wherein the second nozzle is capable of dividing or atomizing the second material to less than or equal to a median diameter of 100 micrometers.

16. The system of claim 14 wherein the first material is identical to or chemically or biologically compatible with the second material.

17. The system of claim 14 wherein the first material is capable of being charged and emitted or sprayed, wherein the first material is capable of depositing preferentially on predetermined parts of the object, wherein the second material is capable of experiencing an electrostatic attraction force to predetermined parts of the object.

18. The system of claim 14 wherein the first material is capable of being charged and emitted or sprayed, wherein the first material is capable of depositing preferentially on predetermined parts of the object, wherein the second material is capable of experiencing an electrostatic repulsion force from predetermined parts of the object.

19. The system of claim 14 wherein the first nozzle and second nozzle are each capable of moving along at least one directions of linear or angular motion with respect to an object, and wherein a minimum or maximum temporal displacement is capable of existing between the first nozzle capable of depositing the first material on the object and the second nozzle capable of depositing the second material on the object.
